(19) United States
(12) Patent Application Publication
(10) Pub. No.: US 2021/0060988 A1
(43) Pub. Date: Mar. 4, 2021

(54) IMAGE FORMING APPARATUS AND CARRIAGE DRIVING METHOD

(71) Applicant: KONICA MINOLTA, INC., Tokyo (JP)

(72) Inventor: Naoya KOMADA, Sagamihara-shi (JP)

(73) Assignee: KONICA MINOLTA, INC., Tokyo (JP)

(21) Appl. No.: 16/986,361

(22) Filed: Aug. 6, 2020

(30) Foreign Application Priority Data
Aug. 30, 2019 (JP) 2019-158028
Aug. 30, 2019 (JP) 2019-158042

(51) Int. Cl. B41J 25/00; B41J 2/21

(52) U.S. Cl. CPC B41J 25/006; B41J 2/21

(57) ABSTRACT

An image forming apparatus includes a placement member, carriages, a support member, a driver and a hardware processor. The placement member has a placement surface. The carriages each include an image forming operation unit that performs an operation for forming an image on a recording medium placed on the placement surface. The support member supports the carriages such that the carriages are reciprocally movable along a predetermined movement path over the placement surface. The driver moves the carriages along the movement path independently from one another. In response to at least two of the carriages being moving along the movement path, the hardware processor controls the driver such that the number of carriages in a predetermined limit-imposed region of the movement path is equal to or less than a predetermined upper limit number that is less than the number of the carriages included in the image forming apparatus.

### CROSS-REFERENCE TO RELATED APPLICATIONS

The entire disclosure of Japanese Patent Applications No. 2019-158028 and No. 2019-158042 both filed on Aug. 30, 2019 are incorporated herein by reference in their entirety.

### BACKGROUND

### Technological Field

The present disclosure relates to an image forming apparatus and a carriage driving method.

### Description of the Related Art

There have been known image forming apparatuses that eject ink from nozzles provided in ink ejection heads to a recording medium(s), thereby forming an image(s). Among these, there is an image forming apparatus that (i) includes a support member that supports a carriage including ink ejection heads such that the carriage is reciprocally movable along a predetermined movement path, and (ii) ejects ink from nozzles of the ink ejection heads to a recording medium(s) at appropriate timings while moving the carriage along the movement path, thereby forming an image(s) on the recording medium. Further, there is known a technology of mounting a plurality of carriages on a support member, and ejecting ink from recording heads of two or more carriages while simultaneously moving the two or more carriages. (Refer to, for example, JP 2016-40083 A.)

### SUMMARY

However, when the number of carriages that are moved simultaneously is increased, a support member sags depending on the weight of the carriages or the strength of the support member, and consequently the distance between (i) the carriages and (ii) a recording medium becomes short, so that landing positions of ink deviate, or the carriages contact the recording medium. Thus, the conventional technology has a problem that images cannot be formed properly due to sagging of a support member.

Objects of the present disclosure include providing an image forming apparatus and a carriage driving method that can form images properly by using a plurality of carriages.

In order to achieve at least one of the abovementioned objects, according to a first aspect of the present disclosure, there is provided an image forming apparatus including:

a placement member having a placement surface on which a recording medium is placed;

a plurality of carriages each including an image forming operation unit that performs an operation for forming an image on the recording medium placed on the placement surface;

a support member that supports the plurality of carriages such that the plurality of carriages are reciprocally movable along a predetermined movement path over the placement surface;

a driver that moves the plurality of carriages along the movement path independently from one another; and

a hardware processor that performs a drive control process of controlling the driver, wherein

in the drive control process, in response to at least two carriages of the plurality of carriages being moving along the movement path, the hardware processor controls the driver such that the number of carriages in a predetermined limit-imposed region of the movement path is equal to or less than a predetermined upper limit number that is less than the number of the plurality of carriages.

In order to achieve at least one of the abovementioned objects, according to a second aspect of the present disclosure, there is provided a carriage driving method for an image forming apparatus including: a placement member having a placement surface on which a recording medium is placed; a plurality of carriages each including an image forming operation unit that performs an operation for forming an image on the recording medium placed on the placement surface; a support member that supports the plurality of carriages such that the plurality of carriages are reciprocally movable along a predetermined movement path over the placement surface; and a driver that moves the plurality of carriages along the movement path independently from one another, the carriage driving method including:

in response to at least two carriages of the plurality of carriages being moving along the movement path, controlling the driver such that the number of carriages in a predetermined limit-imposed region of the movement path is equal to or less than a predetermined upper limit number that is less than the number of the plurality of carriages.

In order to achieve at least one of the abovementioned objects, according to a third aspect of the present disclosure, there is provided an image forming apparatus including:

a placement member having a placement surface on which a recording medium is placed;

a plurality of carriages each including an image forming operation unit that performs an operation for forming an image on the recording medium placed on the placement surface;

a support member that supports the plurality of carriages such that the plurality of carriages are reciprocally movable along a predetermined movement path over the placement surface;

a driver that moves the plurality of carriages along the movement path independently from one another; and

a hardware processor that performs a drive control process of controlling the driver,

wherein the movement path includes a first region and a second region near an end of the movement path compared with the first region, and

wherein in the drive control process, in response to at least two carriages of the plurality of carriages being moving along the movement path, the hardware processor controls the driver such that a distance between any two adjacent carriages of the plurality of carriages in the first region is longer than a distance between the any two adjacent carriages in the second region.

In order to achieve at least one of the abovementioned objects, according to a fourth aspect of the present disclosure, there is provided a carriage driving method for an image forming apparatus including: a placement member having a placement surface on which a recording medium is placed; a plurality of carriages each including an image forming operation unit that performs an operation for forming an image on the recording medium placed on the placement surface; a support member that supports the plurality of carriages such that the plurality of carriages are reciprocally movable along a predetermined movement path over the placement surface; and a driver that moves the plurality of carriages along the movement path independently from one another, the carriage driving method including:

in response to at least two carriages of the plurality of carriages being moving along the movement path, controlling the driver such that a distance between any two adjacent carriages of the plurality of carriages in a first region is longer than a distance between the any two adjacent carriages in a second region, wherein

the movement path includes the first region and the second region near an end of the movement path compared with the first region.

### BRIEF DESCRIPTION OF THE DRAWINGS

The advantages and features provided by one or more embodiments of the present invention will become more fully understood from the detailed description given hereinbelow and the appended drawings that are given by way of illustration only, and thus are not intended as a definition of the limits of the present invention, wherein:

FIG. 1 schematically shows configuration of an inkjet recording apparatus according to a first embodiment (and so forth);

FIG. 2 shows configuration of a carriage;

FIG. 3 shows arrangement of ink ejection heads in carriages;

FIG. 4 is a block diagram showing a main functional configuration of the inkjet recording apparatus;

FIG. 5 shows operation of the carriages in a first mode;

FIG. 6 is a diagram for explaining a carriage driving method of the carriages according to the first embodiment;

FIG. 7 is an illustration for explaining a limit-imposed region and no-limit-imposed regions in detail;

FIG. 8 is a flowchart showing a control procedure that is performed by a controller in an image forming process according to the first embodiment;

FIG. 9 shows arrangement of ink ejection heads in a carriage according to a comparative example;

FIG. 10 is an illustration for explaining printing processes that are performed by the comparative example and an example having the configuration of the first embodiment;

FIG. 11 is an illustration for explaining the carriage driving method of carriages according to a modification 1-1;

FIG. 12 is a flowchart showing the control procedure that is performed by the controller in the image forming process according to a modification 1-2;

FIG. 13 shows arrangement of ink ejection heads in carriages according to a modification 1-3;

FIG. 14 is an illustration for explaining supplementary ejection of ink in the modification 1-3;

FIG. 15 shows arrangement of ink ejection heads in carriages according to a modification 1-4;

FIG. 16 shows configuration of carriages according to a modification 1-5;

FIG. 17 is an illustration for explaining a first region and second regions in detail;

FIG. 18 is a diagram for explaining the carriage driving method of carriages according to a second embodiment;

FIG. 19 is a flowchart showing the control procedure that is performed by the controller in the image forming process according to the second embodiment;

FIG. 20 is a diagram for explaining the carriage driving method of carriages according to a modification 2-1; and

FIG. 21 is a flowchart showing the control procedure that is performed by the controller in the image forming process according to a modification 2-2.

### DETAILED DESCRIPTION OF THE EMBODIMENTS

Hereinafter, one or more embodiments of an image forming apparatus and a carriage driving method of the present invention will be described with reference to the drawings. However, the scope of the present invention is not limited to the disclosed embodiments or illustrated examples.

### First Embodiment

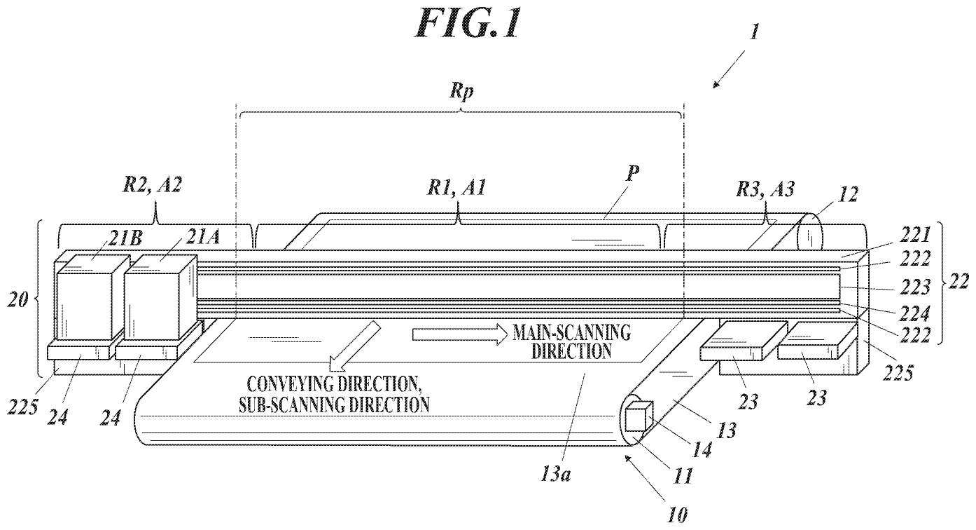

FIG. 1 schematically shows configuration of an inkjet recording apparatus 1 according to a first embodiment.

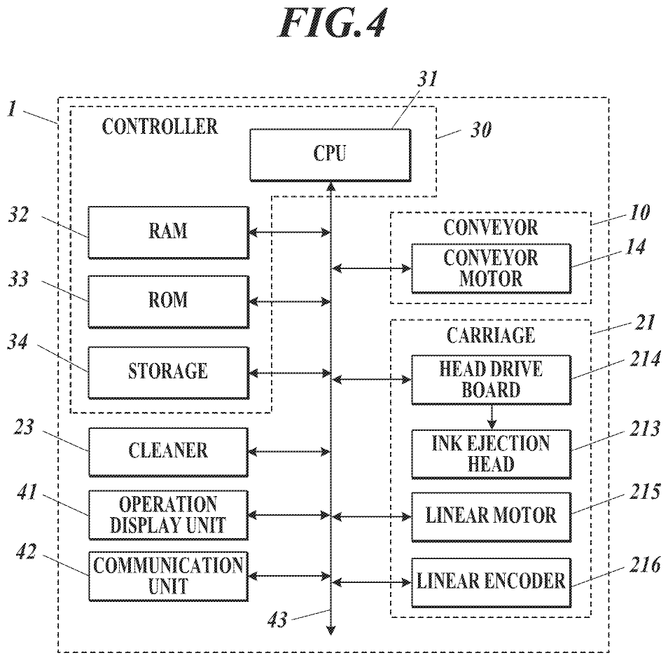

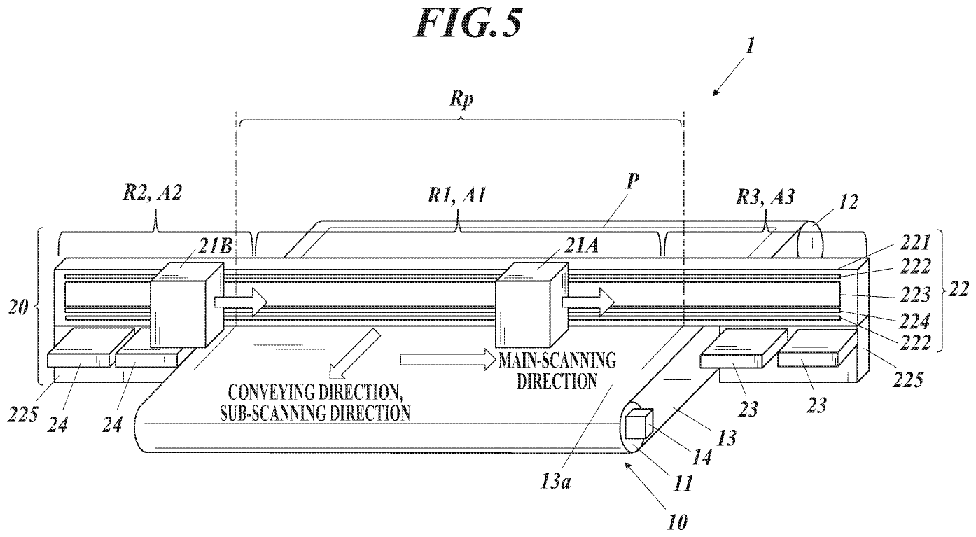

The inkjet recording apparatus 1 (image forming apparatus) includes a conveyor 10, a recorder 20 and a controller 30 (shown in FIG. 4).

The conveyor 10 includes a drive roller 11, a driven roller 12, a conveyor belt 13 (placement member) and a conveyor motor 14.

The drive roller 11 rotates on its rotation axis by drive of the conveyor motor 14. The conveyor belt 13 is a ring-shaped belt the inner side of which is supported by the drive roller 11 and the driven roller 12, and circles as the drive roller 11 rotates. The driven roller 12 rotates on its rotation axis that is in parallel to the rotation axis of the drive roller 11 as the conveyor belt 13 circles. The outer peripheral surface of the conveyor belt 13 constitutes a placement surface 13a on which a recording medium(s) P is placed. The conveyor belt 13 is made of a material that flexibly bends at contact planes/portions with the drive roller 11 and the driven roller 12 and certainly supports the recording medium P. For example, a belt made of resin, such as rubber, or a steel belt can be used. The conveyor belt 13 having a material quality and/or a configuration that attract the recording medium P allows the recording medium P to be more stably placed on the placement surface 13a.

The conveyor motor 14 rotates the drive roller 11 at a rotation speed corresponding to a control signal(s) from the controller 30. The conveyor 10 conveys the recording medium P in a moving direction of the conveyor belt 13 (conveying direction, sub-scanning direction) by the conveyor belt 13 circling at a speed corresponding to the rotation speed of the drive roller 11 in a state in which the recording medium P is placed on the placement surface 13a of the conveyor belt 13. In other words, the conveyor 10 conveys the recording medium P in the conveying direction by moving the placement surface 13 of the conveyor belt 13 in the conveying direction. The conveyor 10 includes a rotary encoder (not shown) that detects the rotation angle of the drive roller 11 and sends the detection result to the controller 30.

FIG. 1 shows a case where the recording medium P is a sheet of paper. However, the recording medium P is not limited to a sheet of paper, and may be roll paper that is unwound (drawn out) from a roll around which the recording medium P is wound, to be supplied onto the conveyor belt 13. The recording medium P may be a medium made of any of various types of material capable of making ink ejected onto its surface adhere thereto, such as fabrics or sheet-shaped resin.

The recording medium P is not particularly limited in size, and hence may be large having a width of about 2 m in the main-scanning direction perpendicular to the sub-scanning direction, for example. The conveyor 10 of this embodiment is configured to convey a large recording medium P having a width of about 2 m in the main-scanning direction. The conveyor 10 may convey a small recording medium P having a width of smaller than 2 m in the main-scanning direction. Alternatively, the conveyor 10 may be configured to convey a large recording medium P having a width of larger than 2 m (e.g. about 4 m) in the main-scanning direction, or may be configured to convey a recording medium P having a width of smaller than 2 m in the main-scanning direction.

The recorder 20 includes: a first carriage 21A and a second carriage 21B (which hereinafter may be referred to as a carriage(s) 21 when no distinction therebetween is needed) each including ink ejection heads 213 that eject ink; a main-scanning rail 22 on which the first carriage 21A and the second carriage 21B are mounted; cleaners 23; and capping units 24 (ink receivers).

The recorder 20 performs a main-scanning operation of ejecting ink from the ink ejection heads 213 of the first carriage 21A and the second carriage 21B to the recording medium P placed on the placement surface 13a, while moving the first carriage 21A and the second carriage 21B along the main-scanning rail 22.

The inkjet recording apparatus 1 alternates (alternately and repeatedly performs) the above-described main-scanning operation with (and) a sub-scanning operation in which the conveyor 10 conveys the recording medium P in the sub-scanning direction for a predetermined distance, thereby forming an image on the recording medium P.

The main-scanning rail 22 includes a support member 221 extending in the main-scanning direction.

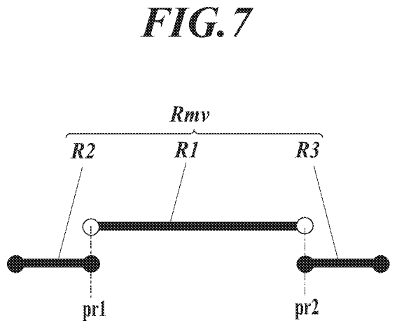

The support member 221 supports the first carriage 21A and the second carriage 21B such that the first carriage 21A and the second carriage 21B are reciprocally movable along a one-dimensional movement path Rmv (shown in FIG. 7) over the placement surface 13a, the movement path Rmv being parallel to the main-scanning direction. The support member 221 of this embodiment is in the shape of a rectangular column, but not limited thereto. Of the support member 221, a mounting surface (a lateral surface facing in the conveying direction in FIG. 1) where the carriages 21 are mounted is provided with a pair of linear guides 222, a linear motor magnet 223 and a linear scale 224.

The linear guides 222 are rails for guiding each carriage 21 in the main-scanning direction. The linear guides 222 have grooves extending in the main-scanning direction. Each carriage 21 is slidable along the linear guides 222 in a state in which mounting members (not shown) of the carriage 21 are fitted in the grooves.

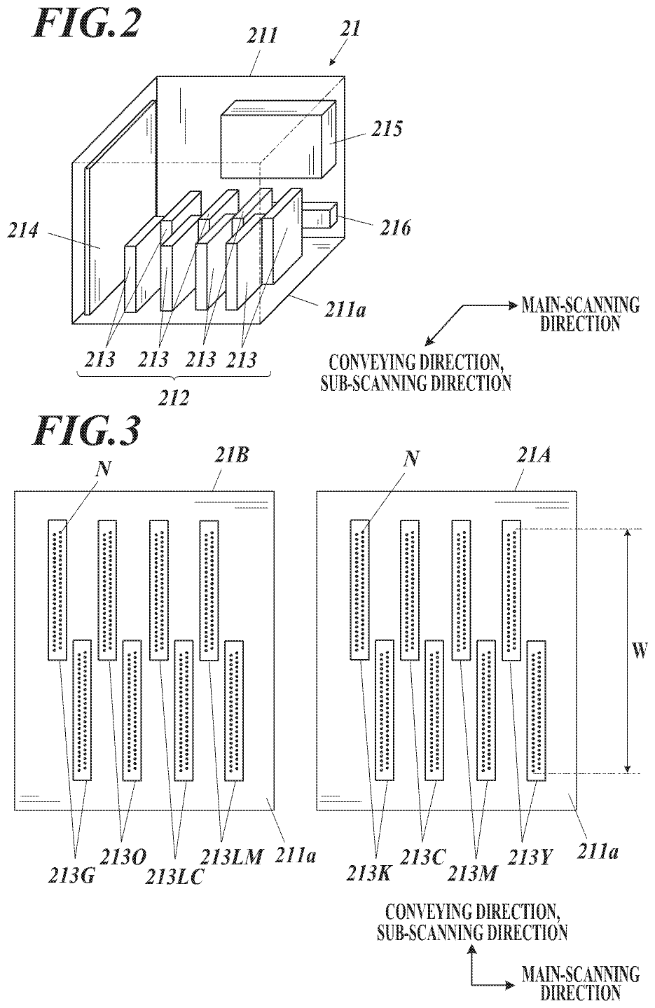

The linear motor magnet 223 is a line-shaped magnet for moving each carriage 21 by operation of a linear motor 215 (driver) (shown in FIG. 2) of the carriage 21, and is equivalent to a stator of a linear motor. More specifically, the linear motor magnet 223 is a magnet line in which N pole and S pole are alternately arranged in the main-scanning direction. In this embodiment, the magnetic pole at each position in the linear motor magnet 223 is fixed, and the magnetic pole of each carriage 21 on the linear motor 215 side changes, so that the carriage 21 moves.

The linear scale 224 is a member extending in the main-scanning direction, and on the surface thereof, divisions that are read by a linear encoder 216 (shown in FIG. 2) of each carriage 21 are engraved.

At respective ends of the support member 221 in the main-scanning direction, support stands 225 that support the support member 221 from underneath in the vertical direction are disposed. In a region between the support stands 225, no member that supports the support member 221 is provided, and hence the support member 221 supports the carriages 21 by its rigidity in the region.

FIG. 2 shows configuration of each carriage 21.

Each carriage 21 includes a case 211, an image forming operation unit 212 housed in the case 211, a head drive board 214, the linear motor 215 (driver) and the linear encoder 216. In FIG. 2, for convenience of explanation, the case 211 is partly depicted in a transparent manner so that the internal configuration of the case 211 can be seen.

The image forming operation unit 212 has eight ink ejection heads 213, and performs an operation for forming an image on (in this embodiment, ejecting ink from the ink ejection heads 213 to) the recording medium P placed on the placement surface 13a of the conveyor belt 13. The image forming operation unit 212 performs the above-described operation when the carriage 21 including this image forming operation unit 212 is in a predetermined image forming region Rp of the movement path Rmv. As the image forming region Rp, a region facing the placement surface 13a or a region excluding vicinities of both ends of the region is set.

The eight ink ejection heads 213 each have a nozzle surface where nozzles for ejecting ink are formed, and are fixed to the case 211 in a state in which the nozzle surfaces are exposed from openings provided in a bottom surface 211a of the case 211. The ink ejection heads 213 are disposed where the distance between the nozzle surfaces during the main-scanning operation and the placement surface 13a of the conveyor belt 13 is a predetermined distance (e.g. about 2 mm).

FIG. 3 shows arrangement of the ink ejection heads 213 in the carriages 21. FIG. 3 shows the bottom surfaces 211a of the first carriage 21A and the second carriage 21B viewed from the placement surface 13a side of the conveyor belt 13.

The first carriage 21A has two ink ejection heads 213Y, two ink ejection heads 213M, two ink ejection heads 213C and two ink ejection heads 213K that eject ink of Y (yellow), M (magenta), C (cyan) and K (black), respectively. Y, M and C are three primary colors used for expressing colors by subtractive mixture, and K is black that is difficult to obtain by superimposing (mixing) these three primary colors only. These four colors are called basic colors (process colors), and are the basic color combination used in various types of image forming apparatus, which include inkjet recording apparatuses, for recording images. The ink ejection heads 213Y, 213M, 213C, 213K correspond to first ink ejection heads.

The second carriage 21B includes two ink ejection heads 213LM, two ink ejection heads 213LC, two ink ejection heads 2130 and two ink ejection heads 213G that eject ink of LM (light magenta), LC (light cyan), O (orange) and G (gray), respectively. LM, LC, O and G are auxiliary colors that are different from the basic colors in hue. Each of the auxiliary colors is used for expressing a color different from a color obtained by a combination of the basic colors, by being mixed with at least one of Y, M and C. The ink ejection heads 213LM, 213LC, 2130, 213G correspond to second ink ejection heads.

Each ink ejection head 213 is provided with two nozzle rows. Each nozzle row is composed of nozzles N arranged one-dimensionally in the sub-scanning direction (arrangement direction) at equal intervals. The two nozzle rows have a positional relationship in which in the sub-scanning direction, the positions of the nozzles N in one nozzle row are different from those in the other nozzle row by ½ of the arrangement pitch (interval) of the nozzles N. The number of nozzle rows is not limited to two, and hence may be one or three or more.

The mechanism for ejecting ink from the nozzles N of each ink ejection head 213 is not particularly limited, but in this embodiment, the following mechanism is used: piezoelectric elements are disposed on wall surfaces of pressure chambers communicating with the nozzles N, and the piezoelectric elements (pressure chambers by extension) are deformed to change pressure applied to ink in the pressure chambers, thereby ejecting the ink from the nozzles N.

Two ink ejection heads 213 that eject ink of the same color are arranged in a positional relationship in which (i) their positions in the main-scanning direction are different from one another and (ii) their end portions overlap one another as viewed in the main-scanning direction in order that an arrangement area of their nozzles N in the sub-scanning direction becomes continuous over a width W in FIG. 3. Further, eight ink ejection heads 213 of each carriage 21 are arranged in a houndstooth check manner.

Returning to FIG. 2, the head drive board 214 is a board on which a head control circuit is mounted. The head control circuit outputs, to the ink ejection heads 213, driving signals for driving the piezoelectric elements on the basis of image data of an image(s) to be recorded. The head drive board 214 is electrically connected to the ink ejection heads 213 through wires (not shown), and outputs the driving signals from the head control circuit to the ink ejection heads 213 at appropriate timings according to the position of the carriage 21 in the main-scanning operation. In FIG. 2, for eight ink ejection heads 213, one head drive board 214 is provided, but for each ink ejection head 213 or for every predetermined number of ink ejection heads 213, one head drive board 214 may be provided.

The linear motor 215 is an electromagnetic motor serving as a drive source for moving the carriage 21 along the linear guides 222 and the linear motor magnet 223. The linear motor 215 is not particularly limited in detailed configuration, but a configuration that controls current to an electromagnetic coil, thereby changing the magnetic pole of the electromagnetic coil, can be used. In this embodiment, the magnetic pole of the linear motor magnet 223 is fixed, and the magnetic pole of each carriage 21 on the linear motor 215 side changes, whereby the carriage 21 is driven. This can move each carriage 21 independently. That is, a movement start timing and a movement end timing can be set for each carriage 21 independently. Further, the carriages 21 can be driven such that (at least) two carriages 21 are moving at least at a timing. Two or more linear motors 215 included in two or more carriages 21, two carriages 21 in this embodiment, constitute a driver.

The linear encoder 216 reads the divisions on the linear scale 224 while the carriage 21 is moving, and outputs, to the controller 30, signals that correspond to the reading results and indicate the position of the carriage 21. The linear encoder 216 includes, for example, an optical sensor that reads divisions, but is not limited thereto. The position of a carriage 21 can be the position of a representative point of the carriage 21. This representative point can be any point of a carriage 21 as long as it is common to carriages 21, and hence may be a point where the optical sensor of the linear encoder 216 is disposed.

Returning to FIG. 1, each cleaner 23 is disposed at a position facing the nozzle surfaces of the ink ejection heads 213 when the carriage 21 reaches a predetermined cleaning position. The cleaner 23 cleans the nozzle surfaces of the carriage 21 that has reached the cleaning position. The cleaning position is set at a position outside the image forming region Rp and near an end of the movement path Rmv on one side (right side in FIG. 1).

Each cleaner 23 wipes and removes ink and other substances adhered to the nozzle surfaces by moving a wiping member (not shown) along the nozzle surfaces in a state in which the wiping member contacts the nozzle surfaces. As the wiping member, a blade made of an elastically deformable material, such as urethane or rubber, can be used. The material of the wiping member is not limited thereto. Other examples thereof include porous members made of resin, such as polyolefin, various fabrics and sponges. FIG. 1 shows that one cleaner 23 is provided for each of the first carriage 21A and the second carriage 21B, but one cleaner 23 may be shared by the carriages 21.

Each capping unit 24 is disposed at a position facing the nozzle surfaces of the ink ejection heads 213 when the carriage 21 reaches a predetermined ink receiving position. The capping unit 24 receives and stores ink ejected by ink flushing from the nozzles N of the ink ejection heads 213. Further, after completion of the flushing, the capping unit 24 covers the nozzle surfaces of the ink ejection heads 213 to prevent the nozzle surfaces from getting dry. The flushing can discharge, to the outside, foreign matters and air bubbles in the nozzles N together with ink. The flushing can be used as an operation (pressure purging) of forcibly discharging ink from the nozzles N by applying a pressure to the ink in the nozzles N from the outside, other than the normal operation of ejecting ink from the nozzles N. The ink receiving position is set at a position outside the image forming region Rp and near an end of the movement path Rmv on the other side (left side in FIG. 1).

FIG. 1 shows that one capping unit 24 is provided for each of the first carriage 21A and the second carriage 21B, but one capping unit 24 may be shared by the carriages 21.

FIG. 4 is a block diagram showing a main functional configuration of the inkjet recording apparatus 1.

The inkjet recording apparatus 1 includes: the conveyor motor 14, which is included in the conveyor 10; the ink ejection heads 213, the head drive boards 214, the linear motors 215 and the linear encoders 216, which are included in the carriages 21; the cleaners 23; the controller 30 (hardware processor); an operation display unit 41; a communication unit 42; and a bus 43. In the following, description of the components already described will be omitted.

The controller 30 includes a CPU (Central Processing Unit) 31, a RAM (Random Access Memory) 32, a ROM (Read Only Memory) 33 and a storage 34.

The CPU 31 reads programs for various types of control and setting data stored in the ROM 33, stores them in the RAM 32, and performs various types of arithmetic processing by executing the programs.

The RAM 32 provides a memory space for working to the CPU 31, and stores temporary data. The RAM 32 may include a nonvolatile memory.

The ROM 33 stores the programs for various types of control that are executed by the CPU 31, the setting data, and so forth. Instead of the ROM 33, a rewritable nonvolatile memory, such as an EEPROM (Electrically Erasable Programmable Read Only Memory) or a flash memory, may be used.

The storage 34 stores print jobs (image forming commands) and image data relevant to the print jobs input from external apparatuses through the communication unit 42. As the storage 34, for example, an HDD (Hard Disk Drive) may be used alone or together with a DRAM (Dynamic Random Access Memory) or the like.

The controller 30 thus configured performs a drive control process, a positional information obtaining process, an ejection control process and so forth by the CPU 31 performing predetermined processes in accordance with their programs, and controls entire operation of the inkjet recording apparatus 1.

For example, the controller 30 sends a control signal(s) to the conveyor motor 14 at an appropriate timing(s), thereby causing the conveyor motor 14 to operate and rotate the drive roller 11, and consequently causing the conveyor 10 to convey the recording medium P for a predetermined distance at a predetermined speed.

Further, in the positional information obtaining process, the controller 30 obtains positional information on the position of each carriage 21 on the movement path Rmv on the basis of signals received from the linear encoder 216.

Further, in the ejection control process, the controller 30 sends image data and a control signal(s) to the head drive board 214 of each carriage 21, thereby causing the head drive board 214 to output driving signals to the ink ejection heads 213 at appropriate timings according to the position of the carriage 21, and consequently causing the ink ejection heads 213 to eject ink from the nozzles N.

Further, in the drive control process, the controller 30 sends a control signal(s) to the linear motor 215 of each carriage 21, thereby causing the linear motor 215 to operate and start moving the carriage 21 in the main-scanning direction at an appropriate timing(s).

Further, the controller 30 sends a control signal(s) to each cleaner 23 at a timing(s) when the carriage 21 reaches the cleaning position, thereby causing the cleaner 23 to clean the carriage 21.

The operation display unit 41 includes a display, such as a liquid crystal display or an organic EL display, and an input device, such as operation keys or a touchscreen overlaid on the screen of the display. The operation display unit 41 displays a variety of information on the display. Further, the operation display unit 41 converts user input operations to the input device into operation signals, and outputs the operation signals to the controller 30.

The communication unit 42 sends and receives data to and from external apparatuses in accordance with predetermined communication standards. The communication unit 42 includes: a connection terminal that conforms to a communication standard to be used; and a hardware driver component (network card) for communication connections.

The bus 43 is a path for sending and receiving signals between the controller 30 and the other components.

Next, an image forming operation that is performed by the inkjet recording apparatus 1 will be described.

As described above, the inkjet recording apparatus 1 alternates the main-scanning operation with the sub-scanning operation, thereby forming an image on the recording medium P. The recorder 20 performs the main-scanning operation of ejecting ink from the ink ejection heads 213 of each carriage 21 to the recording medium P, while moving each carriage 21 along the main-scanning rail 22, and the conveyor 10 performs the sub-scanning operation of conveying the recording medium P in the sub-scanning direction for a predetermined distance.

The controller 30 causes the ink ejection heads 213 to eject ink in a mode chosen between a first mode in which images are formed by a combination of a basic color(s) and an auxiliary color(s) and a second mode in which images are formed with a basic color(s) only, thereby forming an image on the recording medium P. Hence, in the first mode, the first carriage 21A and the second carriage 21B are used for image forming, whereas in the second mode, only the first carriage 21A is used for image forming. A mode is chosen on the basis of, for example, a user input operation to the operation display unit 41. Hereinafter, of these two modes, an operation in the first mode, which uses two carriages 21, will be described in detail.

FIG. 5 shows the operation of the carriages 21 in the first mode.

As shown in FIG. 5, in the first mode, while the first carriage 21A is moving along the support member 221 of the main-scanning rail 22 and performing the main-scanning operation, the second carriage 21B starts moving.

Hence, in a portion of a period of the image forming operation, the first carriage 21A and the second carriage 21B are both moving in the main-scanning direction. In other words, the controller 30 controls the linear motors 215 of the carriages 21 such that (at least) two carriages 21 are moving in a portion of the period of the image forming operation.

However, as described above, in the region between the support stands 225, no member that supports the support member 221 is provided, and hence the support member 221 sags if it receives an excessive load in the vertical direction at a position away from the support stands 225.

These days, due to demands for image forming with a higher throughput and color tone expression with a higher resolution, the number of ink ejection heads 213 disposed on a carriage 21 tends to increase, and accordingly the weight of the carriage 21 tends to increase. Further, in particular, an inkjet recording apparatus 1 for textile or home fabrics is requested to have a longer support member 221 of a main-scanning rail 22 in order to make an image forming width longer. The increase in the weight of each carriage 21 and the increase in the length of the support member 221 both lead the support member 221 to sagging, and hence these days, sagging of the support member 221 tends to be a problem.

In order to prevent the support member 221 from sagging, in this embodiment, the carriages 21 are driven such that the number of carriages 21 in a predetermined limit-imposed region R1 of the movement path Rmv is equal to or less than a predetermined upper limit number. The upper limit number is less than the number of the carriages 21 included in the inkjet recording apparatus 1. In this embodiment, the number of the carriages 21 included in the inkjet recording apparatus 1 is two, and hence the upper limit number is “1”. That is, the carriages 21 are driven such that the number of carriages 21 in the limit-imposed region R1 is one or less at any timing.

The limit-imposed region R1 is a weight-limited region where weight to be applied to the support member 221 is limited. If more carriages 21 than the upper limit number are located in the limit-imposed region R1, the support member 221 sags, so that quality of images to be recorded decreases to a predetermined reference or lower. The decrease in image quality is caused as follows: the support member 221 sags, and consequently the distance between the nozzle surfaces of the ink ejection heads 213 and the recording medium P becomes short, so that landing positions of ink ejected from the nozzles N deviate from desired positions, or depending on the amount of sagging of the support member 221, the nozzle surfaces contact the recording medium P. The acceptable range of the amount of sagging of the support member 221 is about ±100 μm, for example.

In this embodiment, the number of carriages 21 in the limit-imposed region R1 is controlled to be equal to or less than the upper limit number. This efficiently prevents the support member 221 from sagging.

The limit-imposed region R1 corresponds to a portion of the image forming region Rp. In this embodiment, the limit-imposed region R1 is set between both ends of the image forming region Rp, thereby being set in the image forming region Rp. Hence, while one carriage 21 is located in the limit-imposed region R1, the other carriage 21 can be located in the image forming region Rp but outside the limit-imposed region R1. At this timing, the ink ejection heads 213 of the two carriages 21 can eject ink to the same recording medium P simultaneously/parallelly. Hereinafter, a period during which the ink ejection heads 213 of two (or more) carriages 21 eject ink in parallel may be referred to as “parallel ejection period”. The longer the parallel ejection period is, the shorter the image forming time can be. Hence, the controller 30 controls the linear motors 215 of the carriages 21 such that the two carriages 21 are not simultaneously located in the limit-imposed region R1, but simultaneously located in the image forming region Rp at a timing(s).

Hereinafter, of the movement path Rmv, portions outside the limit-imposed region R1 are referred to as no-limit-imposed regions R2, R3. The no-limit-imposed region R2 is a region of the movement path Rmv on one side of the limit-imposed region R1, and the no-limit-imposed region R3 is a region of the movement path Rmv on the other side of the limit-imposed region R1. The no-limit-imposed regions R2, R3 are each a region composed of: a region where the support member 221 is fixed to a component (support stand 225, in this embodiment) of the inkjet recording apparatus 1; and a region near the region, and are each a region where even when more carriages 21 than the abovementioned upper limit number are located, the amount of sagging that affects image quality does not occur in the support member 221.

Next, a carriage driving method of two carriages 21 will be described in detail.

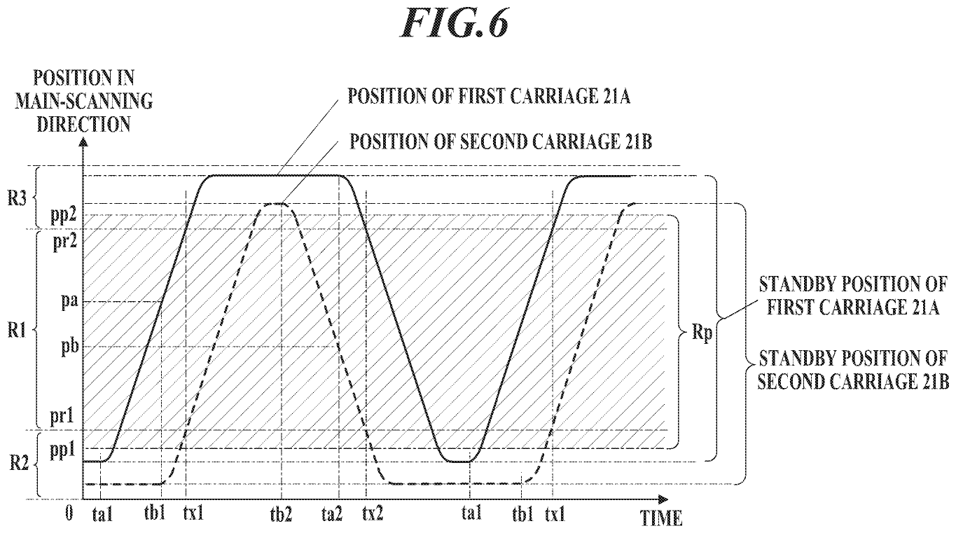

FIG. 6 is a diagram for explaining the carriage driving method.

FIG. 6 shows change in position of each of the first carriage 21A and the second carriage 21B with time. Hereinafter, for convenience, regarding the movement path Rmv, a path from the left end to the right end and a path from the right end to the left end in FIG. 1 will be referred to as an outward path and a homeward path, respectively.

In FIG. 6, the vertical axis represents the position in the main-scanning direction with the left end of the movement path Rmv in FIG. 1 as the origin. A position pp1 is the left end position of the image forming region Rp, and a position pp2 is the right end position of the image forming region Rp. In FIG. 6, the image forming region Rp is hatched. A position pr1 is a boundary position of the limit-imposed region R1 and the no-limit-imposed region R2, and a position pr2 is a boundary position of the limit-imposed region R1 and the no-limit-imposed region R3.

FIG. 7 is an illustration for explaining the limit-imposed region R1 and the no-limit-imposed regions R2, R3 in detail.

Thick lines in FIG. 7 represent the limit-imposed region R1 and the no-limit-imposed regions R2, R3. Of circles at respective ends of each thick line, a black circle indicates that the region includes the end position, whereas a white circle indicates that the region does not include the end position. Hence, the limit-imposed region R1 does not include the positions pr1, pr2, but includes a region inward from the positions pr1, pr2. Further, the no-limit-imposed region R2 includes the position pr1 and a region outward from the position pr1. Further, the no-limit-imposed region R3 includes the position pr2 and a region outward from the position pr2. The movement path Rmv is composed of the limit-imposed region R1 and the no-limit-imposed regions R2, R3.

As shown in FIG. 6, at a point of time (origin of the time axis) when the image forming operation starts, the first carriage 21A and the second carriage 21B are located at their standby positions in the no-limit-imposed region R2. The standby positions in the limit-imposed region R2 are the abovementioned ink receiving positions, that is, the positions facing the capping units 24.

When the image forming operation starts, first, at a timing ta1, the first carriage 21A starts moving. After starting the movement, the first carriage 21A accelerates at a predetermined acceleration, and reaches a predetermined speed before reaching the position pp1. Thereafter, the first carriage 21A ejects ink from the ink ejection heads 213 while moving at a constant speed in the image forming region Rp, thereby performing outward printing.

Next, at a timing tb1 when the first carriage 21A reaches a position pa, the second carriage 21B starts moving. After starting the movement, the second carriage 21B accelerates at a predetermined acceleration, and reaches a predetermined speed before reaching the position pp1. Thereafter, the second carriage 21B ejects ink from the ink ejection heads 213 while moving at a constant speed in the image forming region Rp, thereby performing outward printing.

The speeds of the first carriage 21A and the second carriage 21B in outward printing are equal to one another.

At a timing tx1 when the second carriage 21B reaches the position pr1, the preceding first carriage 21A reaches the position pr2. In other words, the movement start timing tb1 of the second carriage 21B is set such that the first carriage 21A reaches the position pr2 when the second carriage 21B reaches the position pr1. In still other words, the position of the first carriage 21A at a timing earlier than, by a time tm1 (=tx1−tb1), the timing when the first carriage 21A reaches the position pr2 is set as the abovementioned position pa, wherein tm1 represents a time required by the second carriage 21B to reach the position pr1 since the start of the movement.

Thus, before the timing tx1, only the first carriage 21A is located in the limit-imposed region R1, and after the timing tx1, only the second carriage 21B is located in the limit-imposed region R1. Hence, at any timing in outward printing, only one carriage 21, which is the upper limit number, is located in the limit-imposed region R1.

When outward printing finishes, the first carriage 21A and the second carriage 21B stop at their standby positions in the no-limit-imposed region R3. The standby positions in the no-limit-imposed region R3 are the abovementioned cleaning positions, that is, the positions facing the cleaners 23.

When the carriages 21 stop, the conveyor 10 performs the sub-scanning operation. In the sub-scanning operation, the conveyor 10 conveys the recording medium P in the sub-scanning direction for a predetermined distance. In the case of the 1-pass method by which image forming is completed by ink ejection by the main-scanning operation performed one time for each position on the recording medium P, the abovementioned predetermined distance is the width W shown in FIG. 3. In the case of the 2-pass method by which image forming is completed by ink ejection by the main-scanning operation performed twice for each position on the recording medium P, the abovementioned predetermined distance is W/2.

When the sub-scanning operation finishes, at a timing tb2, the second carriage 21B starts moving along the homeward path. After starting the movement, the second carriage 21B accelerates at a predetermined acceleration, and reaches a predetermined speed before reaching the position pp2. Thereafter, the second carriage 21B ejects ink from the ink ejection heads 213 while moving at a constant speed in the image forming region Rp, thereby performing homeward printing.

Next, at a timing ta2 when the second carriage 21B reaches a position pb, the first carriage 21A starts moving. After starting the movement, the first carriage 21A accelerates at a predetermined acceleration, and reaches a predetermined speed before reaching the position pp2. Thereafter, the first carriage 21A ejects ink from the ink ejection heads 213 while moving at a constant speed in the image forming region Rp, thereby performing homeward printing.

The speeds of the first carriage 21A and the second carriage 21B in homeward printing are equal to one another.

At a timing tx2 when the first carriage 21A reaches the position pr2, the preceding second carriage 21B reaches the position pr1. In other words, the movement start timing ta2 of the first carriage 21A is set such that the second carriage 21B reaches the position pr1 when the first carriage 21A reaches the position pr2. In still other words, the position of the second carriage 21B at a timing earlier than, by a time tm2 (=tx2−ta2), the timing when the second carriage 21B reaches the position pr1 is set as the abovementioned position pb, wherein tm2 represents a time required by the first carriage 21A to reach the position pr2 since the start of the movement.

Thus, before the timing tx2, only the second carriage 21B is located in the limit-imposed region R1, and after the timing tx2, only the first carriage 21A is located in the limit-imposed region R1. Hence, at any timing in homeward printing, only one carriage 21, which is the upper limit number, is located in the limit-imposed region R1.

When homeward printing finishes, the second carriage 21B and the first carriage 21A stop at their standby positions in the no-limit-imposed region R2.

When the carriages 21 stop, the conveyor 10 performs the sub-scanning operation.

Thereafter, the same operations are repeated until image forming on the recording medium P is completed.

In the period from the timing ta1 when the first carriage 21A starts moving to the timing tb1 when the second carriage 21B starts moving shown in FIG. 6, the second carriage 21B located at the standby position (ink receiving position) in the limit-imposed region R2 may perform the flushing to the capping unit 24. That is, controlling the linear motors 215 such that one of the carriages 21 is located in the limit-imposed region R1 and the other of the carriages 21 is located at the ink receiving position enables the flushing by making use of the standby time of each carriage 21. The first carriage 21A may also perform the flushing when located at the standby position in the no-limit-imposed region R2.

In the period from the timing tb2 when the second carriage 21B starts moving to the timing ta2 when the first carriage 21A starts moving shown in FIG. 6, the first carriage 21A located at the standby position (cleaning position) in the limit-imposed region R3 may be cleaned by the cleaner 23. That is, controlling the linear motors 215 such that one of the carriages 21 is located in the limit-imposed region R1 and the other of the carriages 21 is located at the cleaning position enables the cleaning by making use of the standby time of each carriage 21. The second carriage 21B may also be cleaned by the cleaner 23 when located at the standby position in the no-limit-imposed region R3.

Next, a control procedure of an image forming process for causing the components of the inkjet recording apparatus 1 to perform the above-described image forming operation will be described.

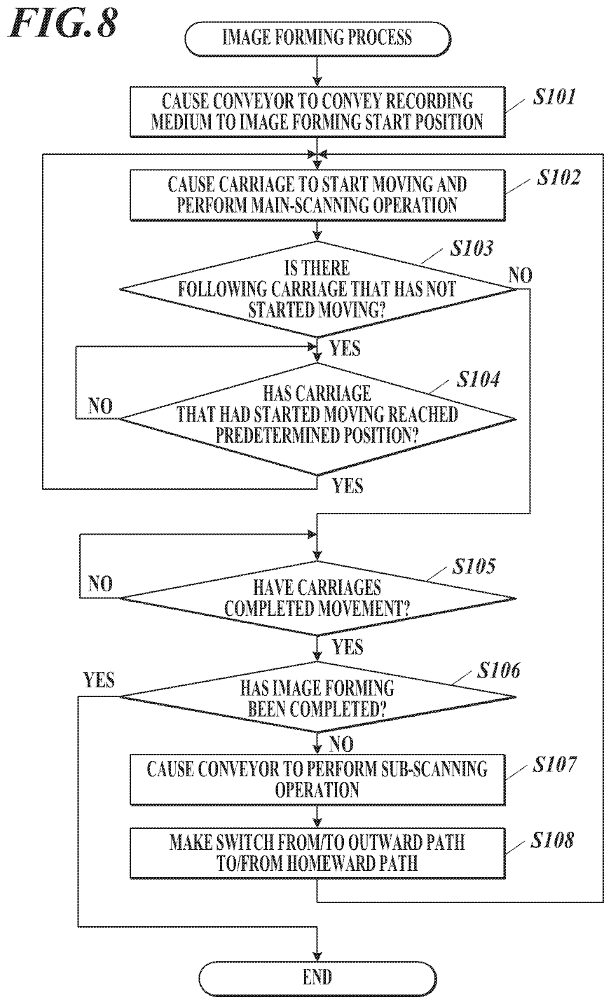

FIG. 8 is a flowchart showing the control procedure that is performed by the controller 30 in the image forming process.

The controller 30 starts the image forming process when a print job and image data are input to the controller 30 through the communication unit 42.

When starting the image forming process, the controller 30 sends a control signal to the conveyor motor 14, thereby causing the conveyor 10 to operate and convey a recording medium P to an image forming start position (Step S101).

The controller 30 causes the lead carriage 21 to start moving and perform the main-scanning operation (Step S102). That is, the controller 30 sends a control signal to the linear motor 215 of the lead carriage 21, thereby causing the lead carriage 21 to start moving, and also starts receiving signals from the linear encoder 216 of the carriage 21, thereby obtaining the positional information on the position of the carriage 21. Further, the controller 30 sends a control signal(s) and the image data to the head drive board 214 at an appropriate timing(s) according to the position of the carriage 21, thereby causing the ink ejection heads 213 of the carriage 21 to eject ink.

The controller 30 determines whether there is a following carriage 21 that has not started moving (Step S103). If the controller 30 determines that there is a following carriage 21 (Step S103; YES), the controller 30 determines whether the carriage 21 that started moving in Step S102 has reached a predetermined position (Step S104). That is, the controller 30 determines whether the first carriage 21A that had started moving earlier has reached the position pa shown in FIG. 6. If the controller 30 determines that the carriage 21 has not reached the predetermined position yet (Step S104; NO), the controller 30 repeats Step S104. If the controller 30 determines that the carriage 21 has reached the predetermined position (Step S104; YES), the controller 30 proceeds to Step S102, and causes the next carriage 21 to start moving and perform the main-scanning operation.

If the controller 30 determines in Step S103 that there is no following carriage 21 that has not started moving (Step S103; NO), the controller 30 determines whether the carriages 21 have completed their movements and stopped at the standby positions in the limit-imposed region R2 or R3 (Step S105). If the controller 30 determines that at least one of the carriages 21 has not completed its movement yet (Step S105; NO), the controller 30 repeats Step S105.

If the controller 30 determines that all (both) the carriages 21 have completed their movements (Step S105; YES), the controller 30 determines whether image forming on the recording medium P has been completed (Step S106). If the controller 30 determines that image forming thereon has not been completed yet (Step S106; NO), the controller 30 causes the conveyor 10 to perform the sub-scanning operation (Step S107). That is, the controller 30 sends a control signal to the conveyor motor 14, thereby causing the conveyor 10 to operate and convey the recording medium P for a predetermined distance. When the sub-scanning operation finishes, the controller 30 makes a switch from/to the outward path to/from the homeward path (Step S108) and proceeds to Step S102.

If the controller 30 determines in Step S106 that image forming on the recording medium P has been completed (Step S106; YES), the controller 30 ends the image forming process.

Steps S102 to S104 in the image forming process correspond to the drive control process.

Next, an effect of reducing the image forming time obtained by the above-described carriage driving method will be described in comparison with a comparative example.

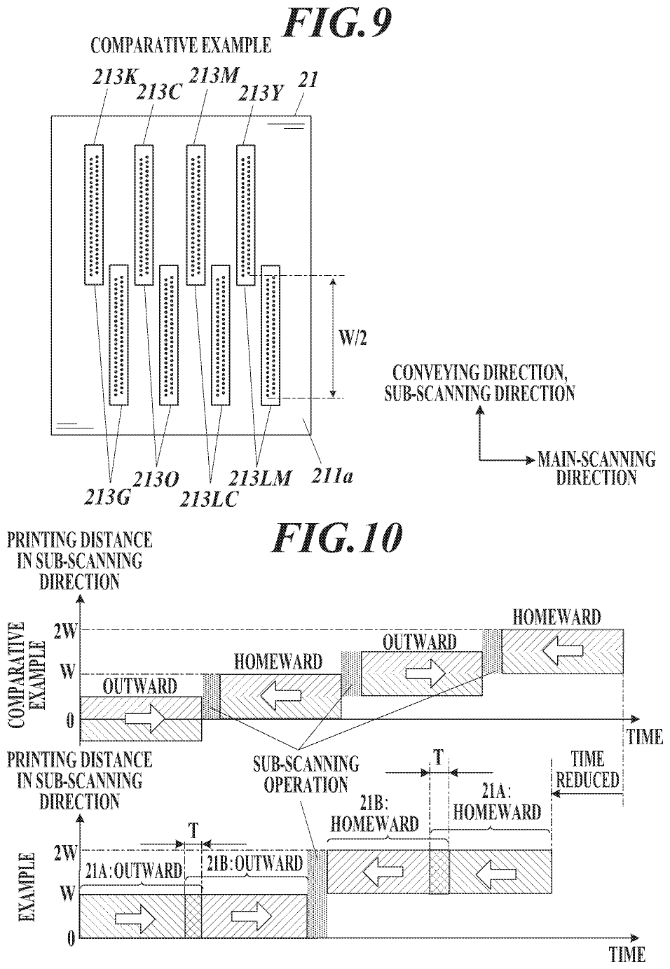

FIG. 9 shows arrangement of ink ejection heads 213 in a carriage 21 according to the comparative example.

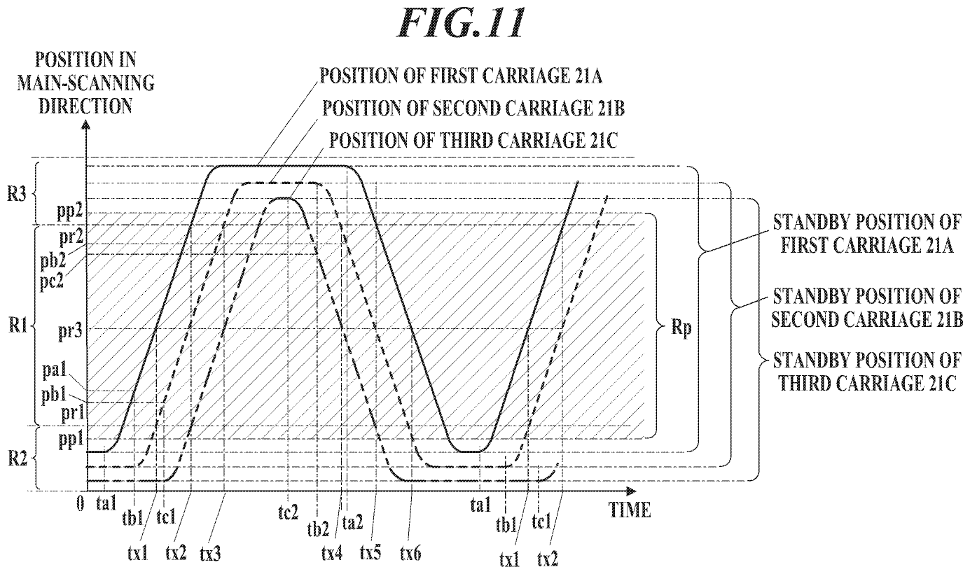

FIG. 10 is an illustration for explaining image forming processes that are performed by the comparative example and an example having the configuration of the first embodiment.

As shown in FIG. 9, the carriage 21 of the comparative example has ink ejection heads 213Y, 213M, 213C, 213K, 213LM, 213LC, 2130, 213G, namely one ink ejection head 213 for each color, and these eight ink ejection heads 213 are arranged in a houndstooth check.

An inkjet recording apparatus of the comparative example forms images by using this one carriage 21 only. More specifically, to positions on a recording medium P, the inkjet recording apparatus of the comparative example first ejects ink of the auxiliary colors from the ink ejection heads 213LM, 213LC, 213O, 213G arranged on the upstream side in the conveying direction, and thereafter performs the sub-scanning operation of conveying the recording medium P for a distance of W/2, and then ejects ink of the basic colors from the ink ejection heads 213Y, 213M, 213C, 213K arranged on the downstream side in the conveying direction.

Hence, as shown in the upper part of FIG. 10, according to the inkjet recording apparatus of the comparative example, each time the outward or homeward main-scanning operation is performed, a portion of an image having a dimension of W/2 in the sub-scanning direction is formed. Hence, for example, in order to form an image having a dimension of 2W in the sub-scanning direction, two round trips of the main-scanning operation need to be made, during which the sub-scanning operation is performed three times.

On the other hand, the inkjet recording apparatus 1 of the example having the configuration of the first embodiment has two ink ejection heads 213 for each color as shown in FIG. 3, and consequently can eject ink of each color over the width W. Hence, as shown in the lower part of FIG. 10, according to the inkjet recording apparatus 1 of the example, each time the outward or homeward main-scanning operation is performed by the two carriages 21, a portion of an image having a dimension of W in the sub-scanning direction is formed. Hence, in order to form an image having a dimension of 2W in the sub-scanning direction, only one round trip of the main-scanning operation needs to be made, during which the sub-scanning operation is performed one time only.

Thus, the number of times the sub-scanning operation needs to be performed in the example is less than that in the comparative example. In addition to this, in the example, a parallel ejection period T, during which the first carriage 21A and the second carriage 21B eject ink simultaneously/parallelly as described above, exists on each path of the main-scanning operation. By this parallel ejection period T, the example can further reduce the image forming time compared with the comparative example.

Next, modifications of the first embodiment will be described. The following modifications can be appropriately combined without departing from the scope of the present invention.

### Modification 1-1

A modification 1-1 is different from the first embodiment in that three carriages 21 are used to form images, but otherwise the same as the first embodiment. Hereinafter, different points from the first embodiment will be described.

In this modification, the first carriage 21A, the second carriage 21B and a third carriage 21C are mounted on the support member 221. The ink ejection heads 213 of the carriages 21 are not particularly limited, but, for example, the third carriage 21C may have eight ink ejection heads 213 that eject ink of colors different from those of the ink ejected from the ink ejection heads 213 of the first carriage 21A and the second carriage 21B.

In this modification, the carriages 21A, 21B, 21C are driven such that the number of carriages 21 in the limit-imposed region R1 is two or less at any timing. That is, the upper limit number of carriages 21 in this modification is “2”.

FIG. 11 is an illustration for explaining the carriage driving method according to the modification 1-1. As shown in FIG. 11, first, at a timing ta1, the first carriage 21A starts moving.

Next, at a timing tb1 when the first carriage 21A reaches a position pal, the second carriage 21B starts moving.

Next, at a timing tc1 when the second carriage 21B reaches a position pb1, the third carriage 21C starts moving.

The speeds of the carriages 21 in outward printing are equal to one another.

At a timing tx1 when the second carriage 21B reaches the position pr1, the preceding first carriage 21A reaches a position pr3 (middle point of the position pr1 and the position pr2). In other words, the movement start timing tb1 of the second carriage 21B is set such that the first carriage 21A reaches the position pr3 when the second carriage 21B reaches the position pr1. In still other words, the position of the first carriage 21A at a timing earlier than, by a time tn1 (=tx1−tb1), the timing when the first carriage 21A reaches the position pr3 is set as the abovementioned position pal, wherein tn1 represents a time required by the second carriage 21B to reach the position pr1 since the start of the movement.

At a timing tx2 when the third carriage 21C reaches the position pr1, the preceding second carriage 21B reaches the position pr3. In other words, the movement start timing tc1 of the third carriage 21C is set such that the second carriage 21B reaches the position pr3 when the third carriage 21C reaches the position pr1. In still other words, the position of the second carriage 21B at a timing earlier than, by a time tn2 (=tx2−tc1), the timing when the second carriage 21B reaches the position pr3 is set as the abovementioned position pb1, wherein tn2 represents a time required by the third carriage 21C to reach the position pr1 since the start of the movement.

At the timing tx2, the first carriage 21A reaches the position pr2, and after the timing tx2, the first carriage 21A moves outside the limit-imposed region R1. Thus, before the timing tx2, only the first carriage 21A is or only the first carriage 21A and the second carriage 21B are located in the limit-imposed region R1, and after the timing tx2, only the third carriage 21C is or only the second carriage 21B and the third carriage 21C are located in the limit-imposed region R1. Hence, at any timing in outward printing, two carriages 21, which is the upper limit number, or less are located in the limit-imposed region R1.

When outward printing finishes, the carriages 21 stop at their standby positions in the no-limit-imposed region R3.

When the third carriage 21C stops (i.e. the carriages 21 stop), the conveyor 10 performs the sub-scanning operation.

When the sub-scanning operation finishes, at a timing tc2, the third carriage 21C starts moving along the homeward path.

Next, at a timing tb2 when the third carriage 21C reaches a position pc2, the second carriage 21B starts moving.

Next, at a timing ta2 when the second carriage 21B reaches a position pb2, the first carriage 21A starts moving.

The speeds of the carriages 21 in homeward printing are equal to one another.

At a timing tx4 when the second carriage 21B reaches the position pr2, the preceding third carriage 21C reaches the position pr3. In other words, the movement start timing tb2 of the second carriage 21B is set such that the third carriage 21C reaches the position pr3 when the second carriage 21B reaches the position pr2. In still other words, the position of the third carriage 21C at a timing earlier than, by a time tn3 (=tx4−tb2), the timing when the third carriage 21C reaches the position pr3 is set as the abovementioned position pc2, wherein tn3 represents a time required by the second carriage 21B to reach the position pr2 since the start of the movement.

At a timing tx5 when the first carriage 21A reaches the position pr2, the preceding second carriage 21B reaches the position pr3. In other words, the movement start timing ta2 of the first carriage 21A is set such that the second carriage 21B reaches the position pr3 when the first carriage 21A reaches the position pr2. In still other words, the position of the second carriage 21B at a timing earlier than, by a time tn4 (=tx5−ta2), the timing when the second carriage 21B reaches the position pr3 is set as the abovementioned position pb2, wherein tn4 represents a time required by the first carriage 21A to reach the position pr2 since the start of the movement.

At the timing tx5, the third carriage 21C reaches the position pr1, and after the timing tx5, the third carriage 21C moves outside the limit-imposed region R1. Thus, before the timing tx5, only the third carriage 21C is or only the second carriage 21B and the third carriage 21C are located in the limit-imposed region R1, and after the timing tx5, only the first carriage 21A is or only the first carriage 21A and the second carriage 21B are located in the limit-imposed region R1. Hence, at any timing in homeward printing, two carriages 21, which is the upper limit number, or less are located in the limit-imposed region R1.

When homeward printing finishes, the carriages 21 stop at their standby positions in the no-limit-imposed region R2.

When the carriages 21 stop, the conveyor 10 performs the sub-scanning operation.

Thereafter, the same operations are repeated until image forming on the recording medium P is completed.

In the above, the upper limit number is “2”, but even in the case where the number of the carriages 21 included in the inkjet recording apparatus 1 is three, the upper limit number may be “1”.

The number of the carriages 21 included in the inkjet recording apparatus 1 may be four or more. In this case too, the movement start timings of the carriages 21 are controlled such that the number of carriages 21 in the limit-imposed region R1 is equal to or less than the upper limit number at any timing. In the case where the number of the carriages 21 included in the inkjet recording apparatus 1 is four, the upper limit number is set to one of “1” to “3”.

### Modification 1-2

Next, a modification 1-2 of the first embodiment will be described. This modification is different from the first embodiment in the method for determining the movement start timings of the carriages 21, but otherwise the same as the first embodiment. Hereinafter, different points from the first embodiment will be described.

In this modification, after causing one of the carriages 21 to start moving, the controller 30 sets, on the basis of the elapsed time since the start of the movement thereof, the movement start timing of the next carriage 21. For example, after causing the first carriage 21A to start moving at the timing ta1 shown in FIG. 6, the controller 30 causes the second carriage 21B to start moving at a timing when a time (tb1−ta1) has elapsed since the start of the movement of the first carriage 21A. The time (tb1−ta1) may be set in advance and stored in the storage 34 or the like as the setting data, or may be calculated on the basis of the acceleration and the speed of the first carriage 21A each time the image forming process is performed.

Similarly, on the homeward path, after causing the second carriage 21B to start moving at the timing tb2, the controller 30 causes the first carriage 21A to start moving at a timing when a time (ta2−tb2) has elapsed since the start of the movement of the second carriage 21B.

The control method of this modification can drive the carriages 21 such that the positions of the carriages 21 at each timing are the same as those shown in FIG. 6.

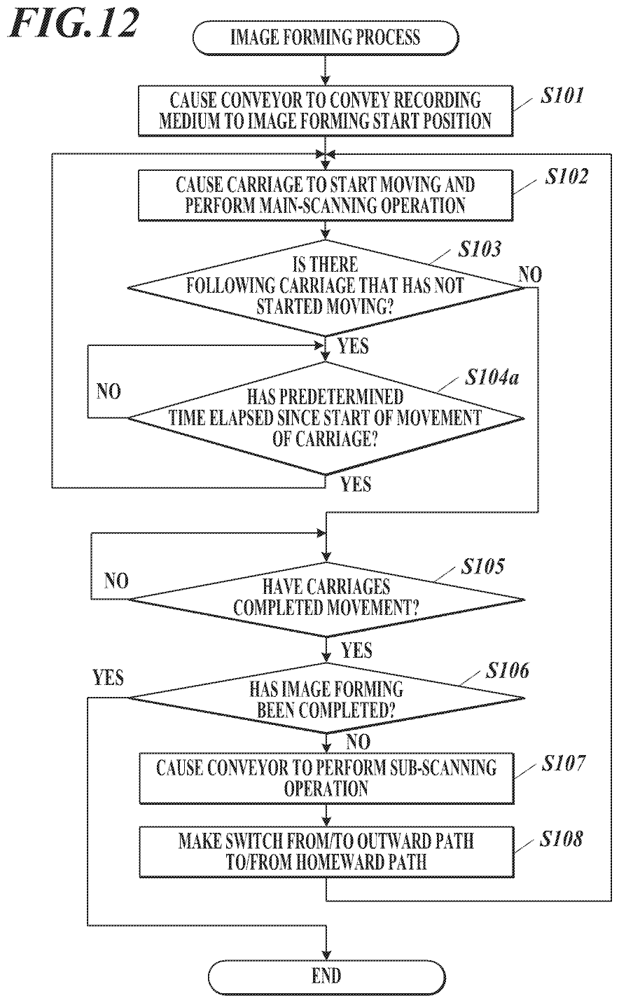

FIG. 12 is a flowchart showing the control procedure that is performed by the controller 30 in the image forming process according to the modification 1-2.

The flowchart shown in FIG. 12 is different from the flowchart shown in FIG. 8 in that Step S104 is replaced by Step S104a, but otherwise the same as the flowchart shown in FIG. 8. Hereinafter, different points from the flowchart shown in FIG. 8 will be described.

In the image forming process shown in FIG. 12, if the controller 30 determines in Step S103 that there is a following carriage 21 that has not started moving (Step S103; YES), the controller 30 determines whether a predetermined time (e.g. the abovementioned time (tb1−ta1) or time (ta2−tb2)) has elapsed since the start of the movement of the carriage 21 in Step S102 (Step S104a). If the controller 30 determines that the predetermined time has not elapsed yet (Step S104a; NO), the controller 30 repeats Step S104a. If the controller 30 determines that the predetermined time has elapsed (Step S104a; YES), the controller 30 proceeds to Step S102, and causes the next carriage 21 to start moving and perform the main-scanning operation.

### Modification 1-3

Next, a modification 1-3 of the first embodiment will be described. This modification is different from the first embodiment in that the two carriages 21 have ink ejection heads 213 that eject ink of the same colors, and in that when an ink ejection head(s) 213 of one carriage 21 dose not eject ink, an ink ejection head(s) 213 of the other carriage 21 supplements the ink not ejected, but otherwise the same as the first embodiment. Hereinafter, different points from the first embodiment will be described.

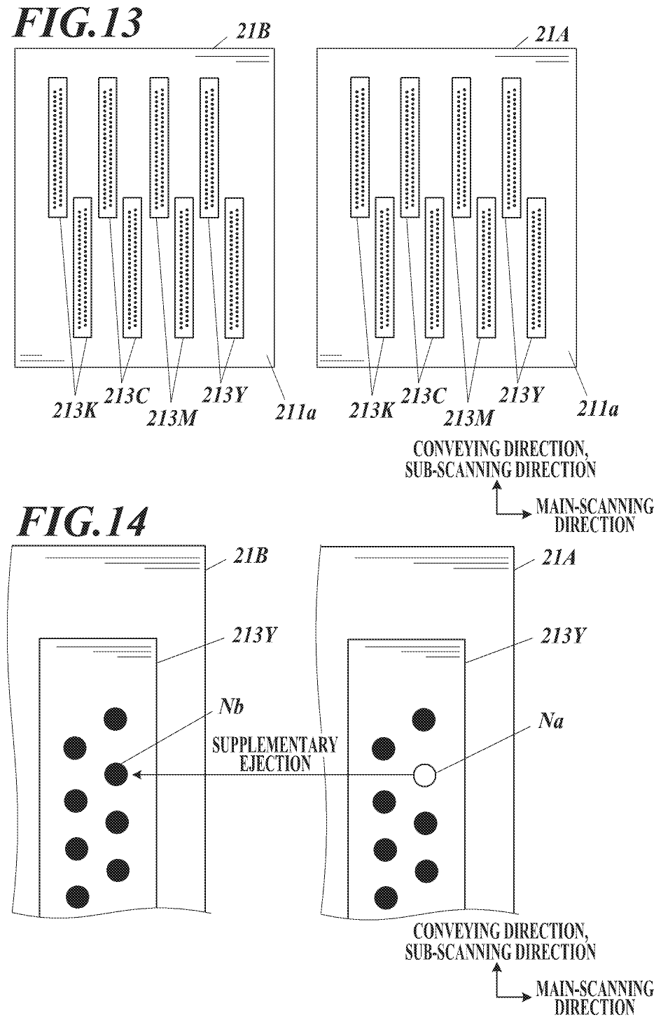

FIG. 13 shows arrangement of the ink ejection heads 213 in the carriages 21 according to the modification 1-3.

In this modification, the first carriage 21A and the second carriage 21B each have two ink ejection heads 213Y, two ink ejection heads 213M, two ink ejection heads 213C and two ink ejection heads 213K, namely two ink ejection heads 213 for each basic color, and have the same arrangement of these eight ink ejection heads 213. The ink ejection heads 213 are arranged such that the positions of the nozzles N of the first carriage 21A in the sub-scanning direction coincide with the positions of the nozzles N of the second carriage 21B in the sub-scanning direction. Thus, the first carriage 21A and the second carriage 21B having the image forming operation units 212 having the ink ejection heads 213 that ejects ink of the same colors can eject ink droplets from their ink ejection heads 213 to the recording medium P placed on the placement surface 13a such that the ink droplets land so as to be laid on top of one another. Hence, adjusting the amounts of ink ejected from the ink ejection heads 213 of the respective carriages 21 can adjust the density of images.

FIG. 14 is an illustration for explaining supplementary ejection of ink in the modification 1-3.

As shown in FIG. 14, in this modification, when a nozzle Na of an ink ejection head 213 of the first carriage 21A is a defective nozzle that cannot eject ink, a nozzle Nb of an ink ejection head 213 of the second carriage 21B that is the same as the nozzle Na in position in the sub-scanning direction performs the supplementary ejection of ink. That is, the controller 30 causes an ink ejection head(s) 213 of a carriage 21 to supplement ink not ejected from an ink ejection head(s) 213 of another carriage 21 to the recording medium P placed on the placement surface 13a, by ejecting ink thereto. This can prevent decrease in image quality due to defective nozzles.

The nozzle that performs the supplementary ejection is not limited to the nozzle Nb that is the same as the defective nozzle Na in position in the conveying direction, and hence a nozzle(s) near the nozzle Nb in the conveying direction may also be used for the supplementary ejection.

Further, the nozzle to be supplemented is not limited to the defective nozzle that cannot eject ink. A nozzle N that is defective in the ink ejection amount or in the ink ejection direction, the nozzle being included in one carriage 21, may be stopped and supplemented by a nozzle(s) N of an ink ejection head 213 of another carriage 21.

### Modification 1-4

Next, a modification 1-4 of the first embodiment will be described. This modification is different from the first embodiment in that the two carriages 21 have ink ejection heads 213 that eject ink of the same colors, and also different therefrom in the positional relationship of the ink ejection heads 213 in the carriages 21, but otherwise the same as the first embodiment. Hereinafter, different points from the first embodiment will be described.

FIG. 15 shows arrangement of (the nozzles of) the ink ejection heads 213 in the carriages 21 according to the modification 1-4.

In the modification 1-4, as with the modification 1-3, the first carriage 21A and the second carriage 21B each have two ink ejection heads 213Y, two ink ejection heads 213M, two ink ejection heads 213C and two ink ejection heads 213K, namely two ink ejection heads 213 for each basic color, and have the same arrangement of these eight ink ejection heads 213.

However, as shown in FIG. 15, in this modification, the positions of the nozzles N of the first carriage 21A in the sub-scanning direction (arrangement direction of the nozzles N) are different from the positions of the nozzles N of the second carriage 21B in the sub-scanning direction. That is, the ink ejection heads 213 of the carriages 21 are arranged in a positional relationship in which the positions of the nozzles N in the sub-scanning direction are different from one another. This can double the recording resolution of images in the sub-scanning direction.

It is possible to provide three or more carriages 21 and make the positions of the nozzles N of the carriages 21 in the sub-scanning direction different from one another. This can further increase the recording resolution in the sub-scanning direction.

In FIG. 15, the positions of the nozzles N in the sub-scanning direction are made to be different from one another by adjusting the mounting positions of the ink ejection heads 213 on the carriages 21, but may be made to be different from one another by adjusting the relative positions of the carriages 21 in the sub-scanning direction.

### Modification 1-5

Next, a modification 1-5 of the first embodiment will be described. This modification is different from the first embodiment in that the image forming operation units 212 of the carriages 21 each have an ultraviolet irradiator 217 and a functional fluid applier 218, but otherwise the same as the first embodiment. Hereinafter, different points from the first embodiment will be described.

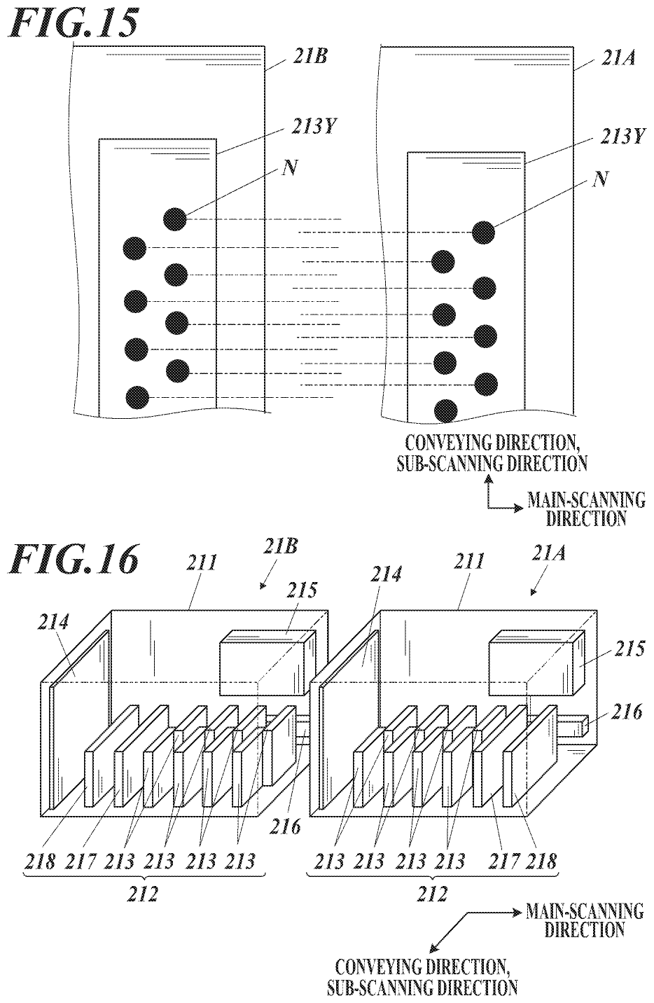

FIG. 16 shows configuration of the carriages 21 according to the modification 1-5.

In this modification, the image forming operation unit 212 of the first carriage 21A includes: the ultraviolet irradiator 217 that irradiates ink ejected on the recording medium P with ultraviolet rays; and the functional fluid applier 218 that applies a predetermined functional fluid to the recording medium P. In the first carriage 21A, the ultraviolet irradiator 217 is arranged on the downstream side of the eight ink ejection heads 213 in the main-scanning direction (i.e. arranged on the lead side on the outward path), and the functional fluid applier 218 is arranged on the downstream side of the ultraviolet irradiator 217 in the main-scanning direction.

The image forming operation unit 212 of the second carriage 21B also includes the ultraviolet irradiator 217 and the functional fluid applier 218. In the second carriage 21B, the ultraviolet irradiator 217 is arranged on the upstream side of the eight ink ejection heads 213 in the main-scanning direction (i.e. arranged on the lead side on the homeward path), and the functional fluid applier 218 is arranged on the upstream side of the ultraviolet irradiator 217 in the main-scanning direction.

The positional relationship of the ultraviolet irradiator 217 and the functional fluid applier 218 in each carriage 21 may be reversed.

The ink ejection heads 213 of this modification eject ultraviolet curable ink, the viscosity of which is increased and which is cured by being irradiated with ultraviolet rays. The ultraviolet irradiator 217 irradiates ink ejected from the ink ejection heads 213 onto the recording medium P with ultraviolet rays, thereby curing the ink. The ultraviolet irradiation by the ultraviolet irradiator 217 is one aspect of the operation for forming an image on the recording medium P placed on the placement surface 13a.

In outward printing, the ultraviolet irradiator 217 of the second carriage 21B located on the rear end side in the travelling direction of the carriages 21 irradiates, with ultraviolet rays, ink ejected from the ink ejection heads 213 of the first carriage 21A and the second carriage 21B onto the recording medium P.

In homeward printing, the ultraviolet irradiator 217 of the first carriage 21A located on the rear end side in the travelling direction of the carriages 21 irradiates, with ultraviolet rays, ink ejected from the ink ejection heads 213 of the first carriage 21A and the second carriage 21B onto the recording medium P.

The functional fluid applier 218 applies, to the recording medium P, a functional fluid for improving image quality of images to be recorded, before ink is ejected. Examples of the functional fluid include: a pretreatment agent for assisting ink in penetrating the recording medium P; a pretreatment agent for preventing ink from penetrating the recording medium P made of a fabric or the like and running on the recording medium P; and a flocculant for clumping dispersed matters, such as pigment particles, in ink by contacting the ink, thereby increasing the viscosity of the ink. The functional fluid application by the functional fluid applier 218 is one aspect of the operation for forming an image on the recording medium P placed on the placement surface 13a.

In outward printing, the functional fluid applier 218 of the first carriage 21A located on the lead side in the travelling direction of the carriages 21 applies the functional fluid to the recording medium P, and then the ink ejection heads 213 of the first carriage 21A and the second carriage 21B eject ink thereto.

In homeward printing, the functional fluid applier 218 of the second carriage 21B located on the lead side in the travelling direction of the carriages 21 applies the functional fluid to the recording medium P, and then the ink ejection heads 213 of the second carriage 21B and the first carriage 21A eject ink thereto.

In this modification, the image forming operation unit 212 of each carriage 21 has the ink ejection heads 213, the ultraviolet irradiator 217 and the functional fluid applier 218, but is not limited thereto. For example, the image forming operation unit 212 of some carriages 21 may each have the ultraviolet irradiator 217 only. In this case, disposing the carriages 21 each having the ultraviolet irradiator 217 on both sides of a carriage(s) 21 having the ink ejection heads 213 allows the ultraviolet irradiators 217 to irradiate ejected ink with ultraviolet rays on both the outward path and the homeward path.

As another example, the image forming operation units 212 of some carriages 21 may each have the functional fluid applier 218 only. In this case, disposing the carriages 21 each having the functional fluid applier 218 on both sides of a carriage(s) 21 having the ink ejection heads 213 allows the functional fluid appliers 218 to apply the functional fluid to the recording medium P to which ink is not ejected yet on both the outward path and the homeward path.

The inkjet recording apparatus 1 may be configured not to have either the ultraviolet irradiator(s) 217 or the functional fluid applier(s) 218.

As described above, the inkjet recording apparatus 1 as an image forming apparatus according to the first embodiment includes: the conveyor belt 13 having the placement surface 13 on which a recording medium P is placed; the plurality of carriages 21 each including the image forming operation unit 212 that performs the operation for forming an image on the recording medium P placed on the placement surface 13a; the support member 221 that supports the plurality of carriages 21 such that the plurality of carriages 21 are reciprocally movable along the predetermined movement path Rmv over the placement surface 13a; the plurality of linear motors 215 (driver) that move the plurality of carriages 21 along the movement path Rmv independently from one another; and the controller 30 that performs the drive control process of controlling the linear motors 215, wherein in the drive control process, in response to at least two carriages 21 of the plurality of carriages 21 being moving along the movement path Rmv, the controller 30 controls the linear motors 215 such that the number of carriages 21 in the predetermined limit-imposed region R1 of the movement path Rmv is equal to or less than a predetermined upper limit number that is less than the number of the plurality of carriages 21.

This can keep the weight to be applied to the support member 221 in the limit-imposed region R1 at a predetermined value or less at any timing, and consequently can keep sagging of the support member 221 within a desired range, which can prevent the problems caused by sagging of the support member 221 from arising, the problems including the following: the distance between the carriages 21 and the recording medium P becomes short, so that landing positions of ink deviate; and the carriages 21 contact the recording medium P. Hence, even when two or more carriages 21 of the plurality of carriages 21 are made to move simultaneously, images can be formed properly, and consequently images can be formed in a short time and the throughput of image forming can be higher. Further, because the strength that the support member 221 needs to have is the strength that can bear the weight of the upper limit number of carriages 21 in the limit-imposed region R1, cost of the support member 221 can be reduced, or the support member 221 can be made longer while increase in cost is prevented or kept low. A longer support member 221 makes it possible to form an image(s) on even a recording medium P having a larger size in the main-scanning direction in a short time. Further, because the support member 221 can be prevented from sagging even when two or more carriages 21 are mounted on one support member 221 and being driven, the support member 221, the linear motor magnet 223, the linear scale 224 and so forth can be shared by the carriages 21. This can efficiently reduce manufacturing cost of the image forming apparatus 1.

Further, the controller 30 performs the positional information obtaining process of obtaining the positional information on the position of each of the plurality of carriages 21 on the movement path Rmv, and in the drive control process, the controller 30 controls the linear motors 215 such that after one carriage 21 of the plurality of carriages 21 starts moving, the next carriage 21 of the plurality of carriages 21 starts moving at its movement start timing set based on the positional information on the position of the one carriage 21. Thus, a simple control makes it possible to prevent the support member 221 from sagging and to form images with a high throughput.

Further, according to the modification 1-2, in the drive control process, the controller 30 controls the linear motors 215 such that after one carriage 21 of the plurality of carriages 21 starts moving, the next carriage 21 of the plurality of carriages 21 starts moving at its movement start timing set based on the time elapsed since the start of the movement of the one carriage 21. Thus, a simple control makes it possible to prevent the support member 221 from sagging and to form images with a high throughput.

Further, the image forming operation unit 212 of each of the plurality of carriages 21 performs the operation when each of the plurality of carriages 21 is in the predetermined image forming region Rp of the movement path Rmv, and the limit-imposed region R1 includes at least a portion of the image forming region Rp. This can prevent decrease in image quality due to sagging of the support member 221 in the image forming region Rp.

Further, the limit-imposed region R1 is set between both ends of the image forming region Rp, thereby being set in the image forming region Rp. Hence, when one carriage 21 is located in the limit-imposed region R1, another carriage 21 can be located in the image forming region Rp but outside the limit-imposed region R1. That is, two or more carriages 21 can be located in the image forming region Rp simultaneously. Simultaneous/parallel ink ejection from the ink ejection heads 213 of the carriages 21 at this timing(s) makes it possible to form images in a shorter time.

Further, in the drive control process, the controller 30 controls the linear motors 215 such that at least two carriages 21 of the plurality of carriages 21 are simultaneously located in the image forming region Rp at a timing(s). This enables simultaneous/parallel ink ejection from the ink ejection heads 213 of two or more carriages 21 to the same recording medium P, and consequently makes it possible to form images in a shorter time.

Further, the image forming operation unit 212 of at least one carriage 21 of the plurality of carriages 21 includes the ink ejection head(s) 213 that ejects ink to the recording medium P, and the controller 30 performs the ejection control process of causing the ink ejection head(s) 213 to eject the ink at a timing(s) according to movement of the at least one carriage 21. This can prevent decrease in image quality due to sagging of the support member 221 and form images properly.

Further, the inkjet recording apparatus 1 further includes the cleaner(s) 23 that cleans the ink ejection head(s) 213 of the at least one carriage 21 located at a predetermined cleaning position outside the image forming region Rp, and in the drive control process, the controller 30 controls the linear motors 215 such that the at least one carriage 21 including the ink ejection head(s) 213 is located at the cleaning position while at least one other carriage 21 of the plurality of carriages 21 is located in the limit-imposed region R1. This makes it possible to clean the ink ejection head(s) 213 during the image forming operation. Hence, as compared with a conventional technology of cleaning the ink ejection head(s) 213 not during the image forming operation, the throughput of image forming can be higher. Further, because the cleaner(s) 23 can be shared by two or more carriages 21, cost can be further reduced.

Further, the inkjet recording apparatus 1 further includes the capping unit(s) 24 that receives the ink ejected from the ink ejection head(s) 213 of the at least one carriage 21 located at a predetermined ink receiving position outside the image forming region Rp, and in the drive control process, the controller 30 controls the linear motors 215 such that the at least one carriage 21 including the ink ejection head(s) 213 is located at the ink receiving position while at least one other carriage 21 of the plurality of carriages 21 is located in the limit-imposed region R1. This makes it possible to cause the ink ejection head(s) 213 to perform the flushing during the image forming operation. Hence, as compared with a conventional technology of causing the ink ejection head(s) 213 to perform the flushing not during the image forming operation, the throughput of image forming can be higher. Further, because the capping unit(s) 24 can be shared by two or more carriages 21, cost can be further reduced.

Further, the image forming operation unit 212 of a carriage 21 of the at least one carriage 21 includes the first ink ejection heads 213 that eject the ink of basic colors, the image forming operation unit 212 of another carriage 21 of the at least one carriage 21 includes the second ink ejection head(s) 213 that ejects the ink of not any of the basic colors but an auxiliary color(s), and in the ejection control process, the controller 30 causes the ink ejection head(s) 213 of the at least one carriage 21 to eject the ink in a mode chosen between the first mode in which the first ink ejection heads 213 and the second ink ejection head(s) 213 eject the ink and the second mode in which the first ink ejection heads 213 eject the ink but the second ink ejection head(s) 213 does not eject the ink. Hence, image forming by a combination(s) of the basic color(s) and the auxiliary color(s) and image forming with the basic color(s) only can be easily switched and performed. Further, in the first mode in which the basic colors and the auxiliary color(s) are used in combination, the support member 221 can be efficiently prevented from sagging.

Further, according to the modification 1-3, the at least one carriage 21 includes at least two carriages 21, the ink ejection heads 213 of the image forming operation units 212 of the at least two carriages 21 eject the ink of the same color(s), and in the ejection control process, the controller 30 causes the ink ejection heads 213 of the at least two carriages 21 to eject the ink such that ink droplets of the ink ejected from the ink ejection heads 213 land on the recording medium P placed on the placement surface 13a so as to be laid on top of one another. Hence, adjusting the amounts of ink ejected from the ink ejection heads 213 of the respective carriages 21 can adjust the density of images to be formed.

Further, according to the modification 1-3, in the ejection control process, the controller 30 causes the ink ejection head(s) 213 of a carriage 21 of the at least two carriages 21 to eject the ink to the recording medium P placed on the placement surface 13a, thereby supplementing the ink not ejected from the ink ejection head(s) 213 of another carriage 21 of the at least two carriages 21. This can prevent decease in image quality even when any of the carriages 21 has an ink ejection head(s) 213 having a nozzle(s) N that is defective in ink ejection.

Further, according to the modification 1-4, the at least one carriage 21 includes at least two carriages 21, the ink ejection heads 213 of the image forming operation units 212 of the at least two carriages 21 eject the ink of the same color, the ink ejection heads 213 each include nozzles N from which the ink is ejected disposed at intervals of a predetermined distance in the arrangement direction that is perpendicular to the moving direction of the plurality of carriages 21, the moving direction being along the movement path Rmv, and the ink ejection heads 213 of the at least two carriages 21 are disposed such that the positions of the nozzles N of the ink ejection heads 213 in the arrangement direction are different from one another. Thus, a simple configuration makes it possible to increase the recording resolution of images in the sub-scanning direction.

Further, according to the modification 1-5, the ink ejection head(s) 213 ejects the ink that is cured by being irradiated with an ultraviolet ray(s), and the image forming operation unit 212 of at least one carriage 21 of the plurality of carriages 21 includes the ultraviolet irradiator 217 that irradiates the ink ejected on the recording medium P with the ultraviolet ray. This makes it possible to cure ink in the main-scanning operation, which is performed by the carriages 21. Because no separate device that emits ultraviolet rays needs to be provided outside the carriages 21, cost can be reduced.

Further, according to the modification 1-5, the image forming operation unit 212 of at least one carriage 21 of the plurality of carriages 21 includes the functional fluid applier 218 that applies a predetermined functional fluid to the recording medium P. This makes it possible to apply a functional fluid to the recording medium P in the main-scanning operation, which is performed by the carriages 21. Because no separate device that applies a functional fluid needs to be provided outside the carriages 21, cost can be reduced.

Further, the inkjet recording apparatus 1 further includes the conveyor 10 that moves the placement surface 13a of the placement member 13 in the conveying direction that intersects the moving direction of the plurality of carriages 21, the moving direction being along the movement path Rmv, thereby conveying the recording medium P in the conveying direction. This makes it possible to form an image in a desired area of the recording medium P by alternating the main-scanning operation, which is performed by the carriages 21, with the sub-scanning operation, which is performed by the conveyor 10.

Further, the carriage driving method according to the first embodiment includes, in response to at least two carriages 21 of the plurality of carriages 21 being moving along the movement path Rmv, controlling the linear motors 215 such that the number of carriages 21 in the predetermined limit-imposed region R1 of the movement path Rmv is equal to or less than a predetermined upper limit number that is less than the number of the plurality of carriages 21. This method can prevent the problems caused by sagging of the support member 221 from arising and form images properly. Further, this method can form images in a short time and make the throughput of image forming higher, while cost can be reduced.

### Second Embodiment

Next, a second embodiment will be described. Hereinafter, description of points shared with the first embodiment will be omitted, and points different from the first embodiment will be described.

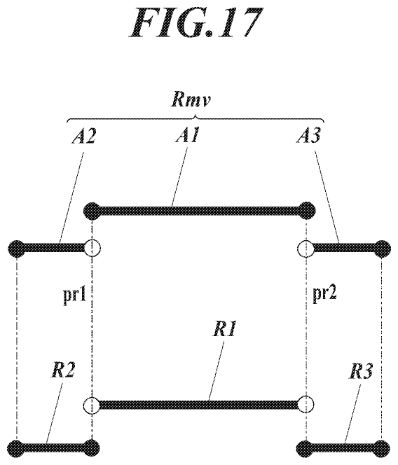

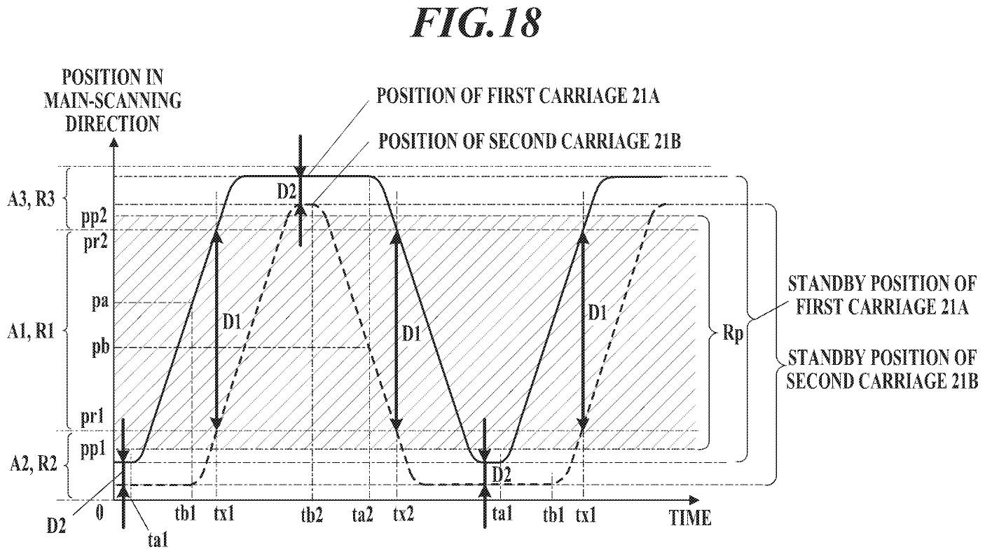

In the second embodiment, in order to prevent the support member 221 from sagging, the carriages 21 are driven such that the distance between adjacent carriages 21 in a first region A1 of a movement path Rmv (shown in FIG. 17) is longer than the distance therebetween in a second region A2 or A3 of the movement path Rmv. In this embodiment, the second region A2 is a region near one end of the movement path Rmv compared with the first region A1, and the second region A3 is a region near the other end of the movement path Rmv compared with the first region A1.

In this embodiment, the carriages 21 are driven such that the number of carriages 21 in a predetermined limit-imposed region R1 that is set between both ends of the first region A1, thereby being set in the first region A1, is equal to or less than a predetermined upper limit number. The upper limit number is less than the number of the carriages 21 included in the inkjet recording apparatus 1. In this embodiment, the number of the carriages 21 included in the inkjet recording apparatus 1 is two, and hence the upper limit number is “1”. That is, the carriages 21 are driven such that the number of carriages 21 in the limit-imposed region R1 is one or less at any timing.

FIG. 17 is an illustration for explaining the first region A1 and the second regions A2, A3 in detail.

Thick lines in FIG. 17 represent regions such as the first region A1 and the second regions A2, A3. Of circles at respective ends of each thick line, a black circle indicates that the region includes the end position, whereas a white circle indicates that the region does not include the end position. A position pr1 is a boundary position of the first region A1 and the second region A2 in the main-scanning direction, and a position pr2 is a boundary position of the first region A1 and the second region A3 in the main-scanning direction.

As shown in FIG. 17, the first region A1 includes the positions pr1, pr2 and a region inward from the positions pr1, pr2. The second region A2 does not include the position pr1, but includes a region outward from the position pr1. The second region A3 does not include the position pr2, but includes a region outward from the position pr2. The movement path Rmv is composed of the first region A1 and the second regions A2, A3.

The limit-imposed region R1 does not include the positions pr1, pr2, but includes a region inward from the positions pr1, pr2. Hence, the limit-imposed region R1 is the first region A1 excluding the positions pr1, pr2, which are positions of both ends of the first region A1. Hereinafter, of the movement path Rmv, a region on one side of the limit-imposed region R1 is a no-limit-imposed region R2, and a region on the other side of the limit-imposed region R1 is a no-limit-imposed region R3.

The first region A1 and the limit-imposed region R1 each correspond to a portion of the image forming region Rp. In this embodiment, the first region A1 and the limit-imposed region R1 are each set between both ends of the image forming region Rp, thereby being set in the image forming region Rp. Hence, while one carriage 21 is located in the limit-imposed region R1, the other carriage 21 can be located in the image forming region Rp but outside the limit-imposed region R1. At this timing, the ink ejection heads 213 of the two carriages 21 can eject ink to the same recording medium P simultaneously/parallelly. Hereinafter, a period during which the ink ejection heads 213 of two (or more) carriages 21 eject ink in parallel may be referred to as “parallel ejection period”. The longer the parallel ejection period is, the shorter the image forming time can be. Hence, the controller 30 controls the linear motors 215 of the carriages 21 such that the two carriages 21 are not simultaneously located in the limit-imposed region R1, but simultaneously located in the image forming region Rp at a timing(s).

Next, a carriage driving method of two carriages 21 will be described in detail.

FIG. 18 is a diagram for explaining the carriage driving method.

FIG. 18 shows change in position of each of the first carriage 21A and the second carriage 21B with time. Hereinafter, for convenience, regarding the movement path Rmv, a path from the left end to the right end and a path from the right end to the left end in FIG. 1 will be referred to as an outward path and a homeward path, respectively.

In FIG. 18, the vertical axis represents the position in the main-scanning direction with the left end of the movement path Rmv in FIG. 1 as the origin. A position pp1 is the left end position of the image forming region Rp, and a position pp2 is the right end position of the image forming region Rp. In FIG. 18, the image forming region Rp is hatched.

As shown in FIG. 18, at a point of time (origin of the time axis) when the image forming starts, the first carriage 21A and the second carriage 21B are located at their standby positions in the second region A2. The standby positions in the second region A2 are the abovementioned ink receiving positions, that is, the positions facing the capping units 24. The distance between the first carriage 21A and the second carriage 21B when they are in the second region A2 is D2.

When the image forming operation starts, first, at a timing ta1, the first carriage 21A starts moving. After starting the movement, the first carriage 21A accelerates at a predetermined acceleration, and reaches a predetermined speed before reaching the position pp1. Thereafter, the first carriage 21A ejects ink from the ink ejection heads 213 while moving at a constant speed in the image forming region Rp, thereby performing outward printing.

Next, at a timing tb1, the second carriage 21B starts moving. That is, at a timing when a time (tb1−ta1) has elapsed since the start of the movement of the first carriage 21A, the second carriage 21B starts moving. After starting the movement, the second carriage 21B accelerates at a predetermined acceleration, and reaches a predetermined speed before reaching the position pp1. Thereafter, the second carriage 21B ejects ink from the ink ejection heads 213 while moving at a constant speed in the image forming region Rp, thereby performing outward printing.

The speeds of the first carriage 21A and the second carriage 21B in outward printing are equal to one another.

At a timing tx1 when the second carriage 21B reaches the position pr1, the preceding first carriage 21A reaches the position pr2. In other words, the time (tb1−ta1) relevant to the movement start timing of the second carriage 21B is set such that the first carriage 21A reaches the position pr2 when the second carriage 21B reaches the position pr1.

At the timing tx1, the first carriage 21A and the second carriage 21B are located in the first region A1 (at the respective ends). The distance between the first carriage 21A and the second carriage 21B at this timing tx1 is D1 and longer than D2. Thus, making the movement start timings of the two carriages 21 different from one another make the distance D1 between the carriages 21 in the first region A1 longer than the distance D2 between the carriages 21 in the second region A2.

After the speeds of the first carriage 21A and the second carriage 21B become constant speeds, the distance between the first carriage 21A and the second carriage 21B is kept at D1. Hence, to put the above in another way, the distance D1 between the first carriage 21A and the second carriage 21B when they are both moving at constant speeds is longer than the distance D2 between the first carriage 21A and the second carriage 21B when they both stay in the second region A2.

Before the timing tx1, only the first carriage 21A is located in the limit-imposed region R1 (first region A1 excluding both ends), and after the timing tx1, only the second carriage 21B is located in the limit-imposed region R1. Hence, at any timing in outward printing, only one carriage 21, which is the upper limit number, is located in the limit-imposed region R1.

When outward printing finishes, the first carriage 21A and the second carriage 21B stop at their standby positions in the second region A3. The standby positions in the second region A3 are the abovementioned cleaning positions, that is, the positions facing the cleaners 23. The distance between the first carriage 21A and the second carriage 21B when they are in the second region A3 is D2.

When the carriages 21 stop, the conveyor 10 performs the sub-scanning operation. In the sub-scanning operation, the conveyor 10 conveys the recording medium P in the sub-scanning direction for a predetermined distance. In the case of the 1-pass method by which image forming is completed by ink ejection by the main-scanning operation performed one time for each position on the recording medium P, the abovementioned predetermined distance is the width W shown in FIG. 3. In the case of the 2-pass method by which image forming is completed by ink ejection by the main-scanning operation performed twice for each position on the recording medium P, the abovementioned predetermined distance is W/2.

When the sub-scanning operation finishes, at a timing tb2, the second carriage 21B starts moving along the homeward path. After starting the movement, the second carriage 21B accelerates at a predetermined acceleration, and reaches a predetermined speed before reaching the position pp2. Thereafter, the second carriage 21B ejects ink from the ink ejection heads 213 while moving at a constant speed in the image forming region Rp, thereby performing homeward printing.

Next, at a timing ta2, the first carriage 21A starts moving. That is, at a timing when a time (ta2−tb2) has elapsed since the start of the movement of the second carriage 21B, the first carriage 21A starts moving. After starting the movement, the first carriage 21A accelerates at a predetermined acceleration, and reaches a predetermined speed before reaching the position pp2. Thereafter, the first carriage 21A ejects ink from the ink ejection heads 213 while moving at a constant speed in the image forming region Rp, thereby performing homeward printing.

The speeds of the first carriage 21A and the second carriage 21B in homeward printing are equal to one another.

At a timing tx2 when the first carriage 21A reaches the position pr2, the preceding second carriage 21B reaches the position pr1. In other words, the time (ta2−tb2) relevant to the movement start timing of the first carriage 21A is set such that the second carriage 21B reaches the position pr1 when the first carriage 21A reaches the position pr2.

At the timing tx2, the first carriage 21A and the second carriage 21B are located in the first region A1 (at the respective ends). The distance between the first carriage 21A and the second carriage 21B at this timing tx2 is D1 and longer than D2 as with in outward printing.

In other words, the distance D1 between the first carriage 21A and the second carriage 21B when they are both moving at constant speeds on the homeward path is longer than the distance D2 between the first carriage 21A and the second carriage 21B when they both stay in the second region A3.

Before the timing tx2, only the second carriage 21B is located in the limit-imposed region R1, and after the timing tx2, only the first carriage 21A is located in the limit-imposed region R1. Hence, at any timing in homeward printing, only one carriage 21, which is the upper limit number, is located in the limit-imposed region R1.

When homeward printing finishes, the second carriage 21B and the first carriage 21A stop at their standby positions in the second region A2.

When the carriages 21 stop, the conveyor 10 performs the sub-scanning operation.

Thereafter, the same operations are repeated until image forming on the recording medium P is completed.

The time (tb1−ta1) and the time (ta2−tb2) may be set in advance and stored in the storage 34 or the like as the setting data, or may be calculated on the basis of the acceleration and the speed of each carriage 21 each time the image forming process is performed.

In the period from the timing ta1 when the first carriage 21A starts moving to the timing tb1 when the second carriage 21B starts moving shown in FIG. 18, the second carriage 21B located at the standby position (ink receiving position) in the second region A2 may perform the flushing to the capping unit 24. That is, controlling the linear motors 215 such that one of the carriages 21 is located in the first region A1 and the other of the carriages 21 is located at the ink receiving position enables the flushing by making use of the standby time of each carriage 21. The first carriage 21A may also perform the flushing when located at the standby position in the second region A2.

In the period from the timing tb2 when the second carriage 21B starts moving to the timing ta2 when the first carriage 21A starts moving shown in FIG. 18, the first carriage 21A located at the standby position (cleaning position) in the second region A3 may be cleaned by the cleaner 23. That is, controlling the linear motors 215 such that one of the carriages 21 is located in the first region A1 and the other of the carriages 21 is located at the cleaning position enables the cleaning by making use of the standby time of each carriage 21. The second carriage 21B may also be cleaned by the cleaner 23 when located at the standby position in the second region A3.

Next, a control procedure of an image forming process for causing the components of the inkjet recording apparatus 1 to perform the above-described image forming operation will be described.

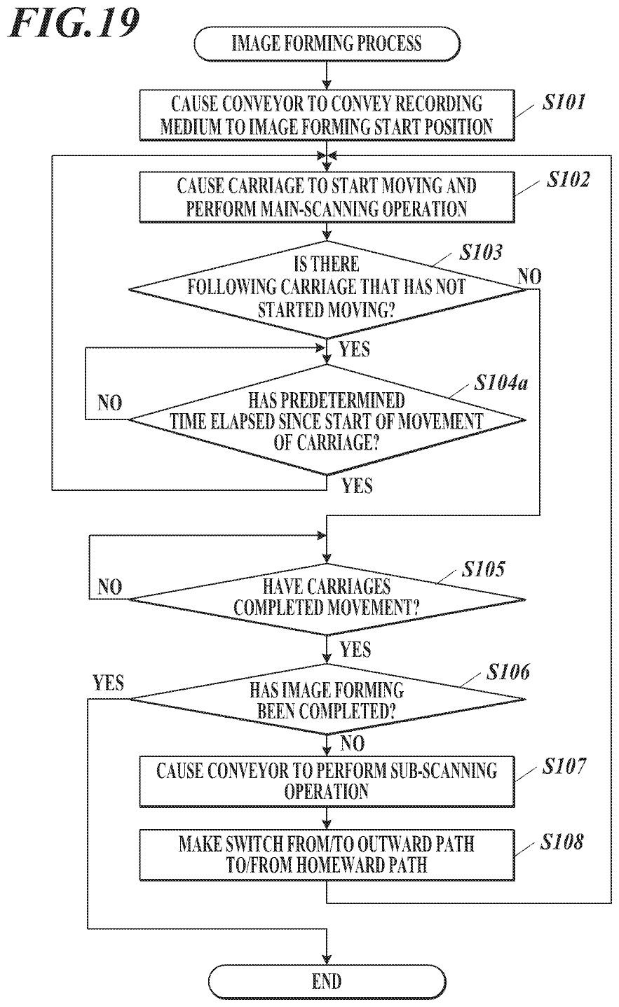

FIG. 19 is a flowchart showing the control procedure that is performed by the controller 30 in the image forming process.

The controller 30 starts the image forming process when a print job and image data are input to the controller 30 through the communication unit 42.

When starting the image forming process, the controller 30 sends a control signal to the conveyor motor 14, thereby causing the conveyor 10 to operate and convey a recording medium P to an image forming start position (Step S101).

The controller 30 causes the lead carriage 21 to start moving and perform the main-scanning operation (Step S102). That is, the controller 30 sends a control signal to the linear motor 215 of the lead carriage 21, thereby causing the lead carriage 21 to start moving. Further, the controller 30 sends a control signal(s) and the image data to the head drive board 214 at an appropriate timing(s) according to the position of the carriage 21, thereby causing the ink ejection heads 213 of the carriage 21 to eject ink.

The controller 30 determines whether there is a following carriage 21 that has not started moving (Step S103). If the controller 30 determines that there is a following carriage 21 (Step S103; YES), the controller 30 determines whether a predetermined time (e.g. the abovementioned time (tb1−ta1) or time (ta2−tb2)) has elapsed since the start of the movement of the carriage 21 in Step S102 (Step S104a). If the controller 30 determines that the predetermined time has not elapsed yet (Step S104a; NO), the controller 30 repeats Step S104a. If the controller 30 determines that the predetermined time has elapsed (Step S104a; YES), the controller 30 proceeds to Step S102, and causes the next carriage 21 to start moving and perform the main-scanning operation.

If the controller 30 determines in Step S103 that there is no following carriage 21 that has not started moving (Step S103; NO), the controller 30 determines whether the carriages 21 have completed their movements and stopped at the standby positions in the limit-imposed region R2 or R3 (Step S105). If the controller 30 determines that at least one of the carriages 21 has not completed its movement yet (Step S105; NO), the controller 30 repeats Step S105.

If the controller 30 determines that all (both) the carriages 21 have completed their movements (Step S105; YES), the controller 30 determines whether image forming on the recording medium P has been completed (Step S106). If the controller 30 determines that image forming thereon has not been completed yet (Step S106; NO), the controller 30 causes the conveyor 10 to perform the sub-scanning operation (Step S107). That is, the controller 30 sends a control signal to the conveyor motor 14, thereby causing the conveyor 10 to operate and convey the recording medium P for a predetermined distance. When the sub-scanning operation finishes, the controller 30 makes a switch from/to the outward path to/from the homeward path (Step S108) and proceeds to Step S102.

If the controller 30 determines in Step S106 that image forming on the recording medium P has been completed (Step S106; YES), the controller 30 ends the image forming process.

Steps S102 to S104a in the image forming process correspond to the drive control process.

Next, modifications of the second embodiment will be described. The following modifications can be appropriately combined without departing from the scope of the present invention. Further, the modification 1-3, the modification 1-4 and the modification 1-5 of the first embodiment and any combination of these are applicable to the second embodiment too.

### Modification 2-1

A modification 2-1 is different from the second embodiment in that three carriages 21 are used to form images, but otherwise the same as the second embodiment. Hereinafter, different points from the second embodiment will be described.

In this modification, the first carriage 21A, the second carriage 21B and a third carriage 21C are mounted on the support member 221. The ink ejection heads 213 of the carriages 21 are not particularly limited, but, for example, the third carriage 21C may have eight ink ejection heads 213 that eject ink of colors different from those of the ink ejected from the ink ejection heads 213 of the first carriage 21A and the second carriage 21B.

In this modification, the carriages 21A, 21B, 21C are driven such that the number of carriages 21 in the limit-imposed region R1 is two or less at any timing. That is, the upper limit number of carriages 21 in this modification is “2”.

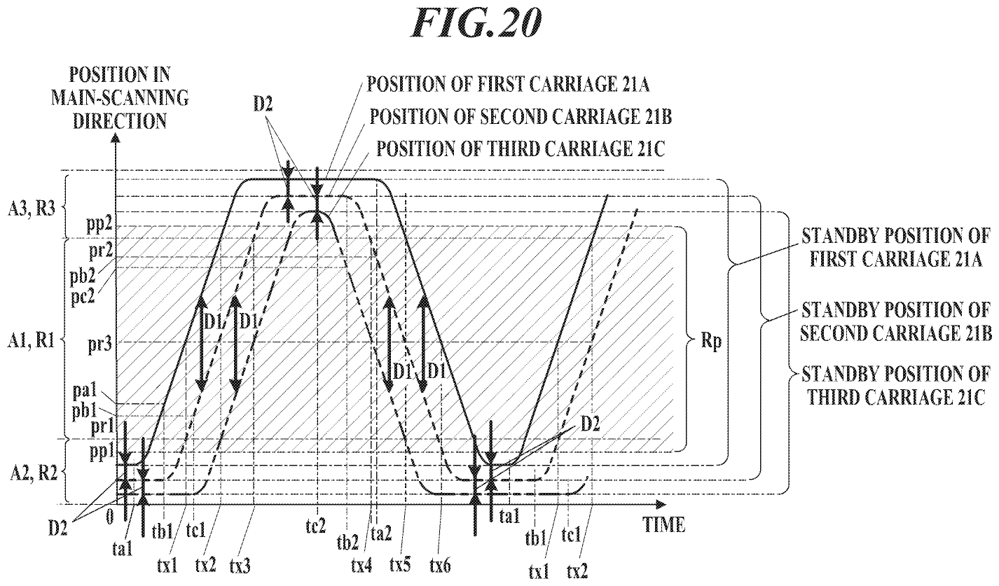

FIG. 20 is an illustration for explaining the carriage driving method according to the modification 2-1.

As shown in FIG. 20, the distance between adjacent carriages 21 when three carriages 21 are in the second region A2, namely each of the distance between the first carriage 21A and the second carriage 21B and the distance between the second carriage 21B and the third carriage 21C in the second region A2, is D2.

First, at a timing ta1, the first carriage 21A starts moving.

Next, at a timing tb1, namely at a timing when a time (tb1−ta1) has elapsed since the start of the movement of the first carriage 21A, the second carriage 21B starts moving.

Next, at a timing tc1, namely at a timing when a time (tc1−tb1) has elapsed since the start of the movement of the second carriage 21B, the third carriage 21C starts moving.

The speeds of the carriages 21 in outward printing are equal to one another.

At a timing tx1 when the second carriage 21B reaches the position pr1, the preceding first carriage 21A reaches a position pr3 (middle point of the position pr1 and the position pr2). In other words, the time (tb1−ta1) relevant to the movement start timing of the second carriage 21B is set such that the first carriage 21A reaches the position pr3 when the second carriage 21B reaches the position pr1.

At a timing tx2 when the third carriage 21C reaches the position pr1, the preceding second carriage 21B reaches the position pr3. In other words, the time (tc1−tb1) relevant to the movement start timing of the third carriage 21C is set such that the second carriage 21B reaches the position pr3 when the third carriage 21C reaches the position pr1.

At the timing tx2, the first carriage 21A reaches the position pr2, and after the timing tx2, the first carriage 21A moves outside the first region A1.

At a timing tx3, the second carriage 21B reaches the position pr2, and after the timing tx3, the second carriage 21B moves outside the first region A1.

From the timing tx1 to the timing tx2, the first carriage 21A and the second carriage 21B are located in the first region A1, and the distance therebetween is D1 (>D2). From the timing tx2 to the timing tx3, the second carriage 21B and the third carriage 21C are located in the first region A1, and the distance therebetween is D1 (>D2). Thus, in this modification too, making the movement start timings of the carriages 21 different from one another make the distance D1 between any two adjacent carriages 21 in the first region A1 longer than the distance D2 between the adjacent carriages 21 in the second region A2.

Before the timing tx2, only the first carriage 21A is or only the first carriage 21A and the second carriage 21B are located in the limit-imposed region R1, and after the timing tx2, only the third carriage 21C is or only the second carriage 21B and the third carriage 21C are located in the limit-imposed region R1. Hence, at any timing in outward printing, two carriages 21, which is the upper limit number, or less are located in the limit-imposed region R1.

When outward printing finishes, the carriages 21 stop at their standby positions in the second region A3. The distance between adjacent carriages 21 when three carriages 21 are in the second region A3, namely each of the distance between the first carriage 21A and the second carriage 21B and the distance between the second carriage 21B and the third carriage 21C in the second region A3, is D2.

When the carriages 21 stop, the conveyor 10 performs the sub-scanning operation.

When the sub-scanning operation finishes, at a timing tc2, the third carriage 21C starts moving along the homeward path.

Next, at a timing tb2, namely at a timing when a time (tb2−tc2) has elapsed since the start of the movement of the third carriage 21C, the second carriage 21B starts moving.

Next, at a timing ta2, namely at a timing when a time (ta2−tb2) has elapsed since the start of the movement of the second carriage 21B, the first carriage 21C starts moving.

The speeds of the carriages 21 in homeward printing are equal to one another.

At a timing tx4 when the second carriage 21B reaches the position pr2, the preceding third carriage 21C reaches the position pr3. In other words, the time (tb2−tc2) relevant to the movement start timing of the second carriage 21B is set such that the third carriage 21C reaches the position pr3 when the second carriage 21B reaches the position pr2.

At a timing tx5 when the first carriage 21A reaches the position pr2, the preceding second carriage 21B reaches the position pr3. In other words, the time (ta2−tb2) relevant to the movement start timing of the first carriage 21A is set such that the second carriage 21B reaches the position pr3 when the first carriage 21A reaches the position pr2.

At the timing tx5, the third carriage 21C reaches the position pr1, and after the timing tx5, the third carriage 21C moves outside the limit-imposed region R1.

At a timing tx6, the second carriage 21B reaches the position pr1, and after the timing tx6, the second carriage 21B moves outside the limit-imposed region R1.

From the timing tx4 to the timing tx5, the third carriage 21C and the second carriage 21B are located in the first region A1, and the distance therebetween is D1 (>D2). From the timing tx5 to the timing tx6, the second carriage 21B and the first carriage 21A are located in the first region A1, and the distance therebetween is D1 (>D2). Thus, on the homeward path too, making the movement start timings of the carriages 21 different from one another make the distance D1 between any two adjacent carriages 21 in the first region A1 longer than the distance D2 between the adjacent carriages 21 in the second region A3.

Before the timing tx5, only the third carriage 21C is or only the second carriage 21B and the third carriage 21C are located in the limit-imposed region R1, and after the timing tx5, only the first carriage 21A is or only the first carriage 21A and the second carriage 21B are located in the limit-imposed region R1. Hence, at any timing in homeward printing, two carriages 21, which is the upper limit number, or less are located in the limit-imposed region R1.

When homeward printing finishes, the carriages 21 stop at their standby positions in the second region A2.

When the carriages 21 stop, the conveyor 10 performs the sub-scanning operation.

Thereafter, the same operations are repeated until image forming on the recording medium P is completed.

In the above, the upper limit number is “2”, but even in the case where the number of the carriages 21 included in the inkjet recording apparatus 1 is three, the upper limit number may be “1”.

The number of the carriages 21 included in the inkjet recording apparatus 1 may be four or more. In this case too, the movement start timings of the carriages 21 are controlled such that the number of carriages 21 in the limit-imposed region R1 is equal to or less than the upper limit number at any timing. In the case where the number of the carriages 21 included in the inkjet recording apparatus 1 is four, the upper limit number is set to one of “1” to “₃”_{.}

### Modification 2-2

Next, a modification 2-2 of the second embodiment will be described. This modification is different from the second embodiment in the method for determining the movement start timings of the carriages 21, but otherwise the same as the second embodiment. Hereinafter, different points from the second embodiment will be described.

In this modification, after causing one of the carriages 21 to start moving, the controller 30 obtains the positional information on the position of the carriage 21 on the basis of a signal(s) received from the linear encoder 216 of the carriage 21. The controller 30 sets the movement start timing of the next carriage 21 on the basis of this positional information.

More specifically, in the case shown in FIG. 18 where two carriages 21 are used, after causing the first carriage 21A to start moving at the timing ta1, the controller 30 causes the second carriage 21B to start moving at the timing tb1 when the first carriage 21A reaches a position pa. The position pa is the position of the first carriage 21A at a timing earlier than, by a time tm1 (=tx1−tb1), the timing when the first carriage 21A reaches the position pr2, wherein tm1 represents a time required by the second carriage 21B to reach the position pr1 since the start of the movement at the timing tb1.

Similarly, on the homeward path, after causing the second carriage 21B to start moving at the timing tb2, the controller 30 causes the first carriage 21A to start moving at the timing ta2 when the second carriage 21B reaches a position pb. The position pb is the position of the second carriage 21B at a timing earlier than, by a time tm2 (=tx2 ta2), the timing when the second carriage 21B reaches the position pr1, wherein tm2 represents a time required by the first carriage 21A to reach the position pr2 since the start of the movement at the timing ta2.

The control method of this modification can drive the carriages 21 such that the positions of the carriages 21 at each timing are the same as those shown in FIG. 18.

In the case shown in FIG. 20 where three carriages 21 are used, after causing the first carriage 21A to start moving at the timing ta1, the controller 30 causes the second carriage 21B to start moving at the timing tb1 when the first carriage 21A reaches a position pal. The position pal is the position of the first carriage 21A at a timing earlier than, by a time tn1 (=tx1−tb1), the timing when the first carriage 21A reaches the position pr3, wherein tn1 represents a time required by the second carriage 21B to reach the position pr1 since the start of the movement at the timing tb1.

Further, after causing the second carriage 21b to start moving at the timing tb1, the controller 30 causes the third carriage 21c to start moving at the timing tc1 when the second carriage 21B reaches a position pb1. The position pb1 is the position of the second carriage 21B at a timing earlier than, by a time tn2 (=tx2−tc1), the timing when the second carriage 21B reaches the position pr3, wherein tn2 represents a time required by the third carriage 21C to reach the position pr1 since the start of the movement at the timing tc1.

Similarly, on the homeward path, after causing the third carriage 21C to start moving at the timing tc2, the controller 30 causes the second carriage 21B to start moving at the timing tb2 when the third carriage 21C reaches a position pc2. The position pc2 is the position of the third carriage 21C at a timing earlier than, by a time tn3 (=tx4−tb2), the timing when the third carriage 21C reaches the position pr3, wherein tn3 represents a time required by the second carriage 21B to reach the position pr3 since the start of the movement at the timing tb2.

Further, after causing the second carriage 21b to start moving at the timing tb2, the controller 30 causes the first carriage 21A to start moving at the timing ta2 when the second carriage 21B reaches a position pb2. The position pb2 is the position of the second carriage 21B at a timing earlier than, by a time tn4 (=tx5−ta2), the timing when the second carriage 21B reaches the position pr3, wherein tn4 represents a time required by the first carriage 21A to reach the position pr3 since the start of the movement at the timing ta2.

The control method of this modification can drive the carriages 21 such that the positions of the carriages 21 at each timing are the same as those shown in FIG. 20.

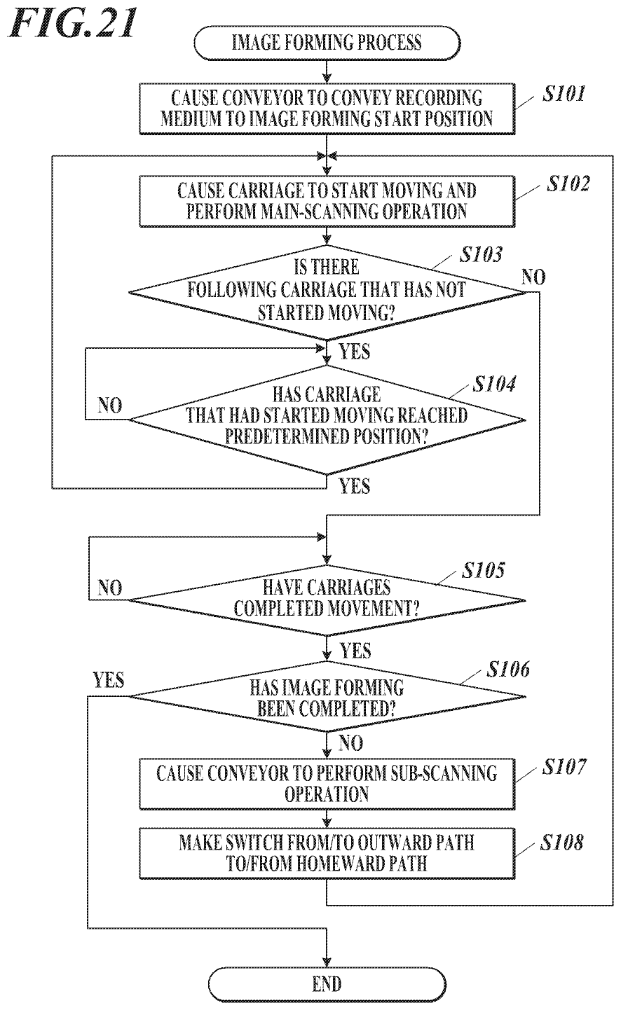

FIG. 21 is a flowchart showing the control procedure that is performed by the controller 30 in the image forming process according to the modification 2-2.

The flowchart shown in FIG. 21 is different from the flowchart shown in FIG. 19 in that Step S104a is replaced by Step S104, but otherwise the same as the flowchart shown in FIG. 19. Hereinafter, different points from the flowchart shown in FIG. 19 will be described.

In the image forming process shown in FIG. 21, in Step S102, the controller 30 sends a control signal to the linear motor 215 of the lead carriage 21, thereby causing the lead carriage 21 to start moving, and also starts receiving signals from the linear encoder 216 of the carriage 21, thereby obtaining the positional information on the position of the carriage 21.

Further, in Step S103, if the controller 30 determines that there is a following carriage 21 that has not started moving (Step S103; YES), the controller 30 determines whether the carriage 21 that started moving in Step S102 has reached a predetermined position (Step S104). For example, in the case shown in FIG. 18, the controller 30 determines whether the first carriage 21A that had started moving earlier has reached the position pa shown in FIG. 18. If the controller 30 determines that the carriage 21 has not reached the predetermined position yet (Step S104; NO), the controller 30 repeats Step S104. If the controller 30 determines that the carriage 21 has reached the predetermined position (Step S104; YES), the controller 30 proceeds to Step S102, and causes the next carriage 21 to start moving and perform the main-scanning operation.

As described above, the inkjet recording apparatus 1 as an image forming apparatus according to the second embodiment includes: the conveyor belt 13 having the placement surface 13a on which a recording medium P is placed; the plurality of carriages 21 each including the image forming operation unit 212 that performs the operation for forming an image on the recording medium P placed on the placement surface 13a; the support member 221 that supports the plurality of carriages 21 such that the plurality of carriages 21 are reciprocally movable along the predetermined movement path Rmv over the placement surface 13a; the plurality of linear motors 215 (driver) that move the plurality of carriages 21 along the movement path Rmv independently from one another; and the controller 30 that performs the drive control process of controlling the linear motors 215, wherein the movement path Rmv includes the first region A1 and the second region A2/A3 near an end of the movement path Rmv compared with the first region A1, and wherein in the drive control process, in response to at least two carriages 21 of the plurality of carriages 21 being moving along the movement path Rmv, the controller 30 controls the linear motors 215 such that the distance between any two adjacent carriages 21 of the plurality of carriages 21 in the first region A1 is longer than the distance between the any two adjacent carriages 21 in the second region A2/A3.

This can prevent many carriages 21 from being concentratedly located in the first region A1, which is at the center portion of the movement path Rmv, at any timing. Hence, this can keep the weight to be applied to the support member 221 in the limit-imposed region R1 at a predetermined value or less at any timing, and consequently can keep sagging of the support member 221 within a desired range, which can prevent the problems caused by sagging of the support member 221 from arising, the problems including the following: the distance between the carriages 21 and the recording medium P becomes short, so that landing positions of ink deviate; and the carriages 21 contact the recording medium P. Hence, even when two or more carriages 21 of the plurality of carriages 21 are made to move simultaneously, images can be formed properly, and consequently images can be formed in a short time and the throughput of image forming can be higher. Further, because the strength required for the support member 221 can be reduced, cost of the support member 221 can be reduced, or the support member 221 can be made longer while increase in cost is prevented or kept low. A longer support member 221 makes it possible to form an image(s) on even a recording medium P having a larger size in the main-scanning direction in a short time. Further, because the support member 221 can be prevented from sagging even when two or more carriages 21 are mounted on one support member 221 and being driven, the support member 221, the linear motor magnet 223, the linear scale 224 and so forth can be shared by the carriages 21. This can efficiently reduce manufacturing cost of the image forming apparatus 1.

Further, the second region A2/A3 is disposed on each of both sides of the first region A1. This allows the carriages 21 to perform the following series of operations on both the outward path and the homeward path of the movement path Rmv: (i) before starting to move, the carriages 21 stay in the second region A2 (A3) with a short distance therebetween; (ii) when starting to move, the carriages 21 move so as to increase the distance therebetween in the first region A1; and (iii) when finishing moving, the carriages 21 stay in the second region A3 (A2) on the other side with a short distance therebetween. Hence, the outward main-scanning operation and the homeward main-scanning operation can be performed repeatedly while the support member 221 is prevented from sagging.

Further, in the drive control process, the controller 30 controls the linear motors 215 such that the number of carriages 21 in the predetermined limit-imposed region R1 that is set between both ends of the first region A1, thereby being set in the first region A1, is equal to or less than a predetermined upper limit number that is less than the number of the plurality of carriages 21. This can more certainly keep the weight to be applied to the support member 221 in the limit-imposed region R1 at a predetermined value or less at any timing, and consequently can keep sagging of the support member 221 within a desired range.

Further, in the drive control process, the controller 30 controls the linear motors 215 such that after one carriage 21 of the plurality of carriages 21 starts moving, the next carriage 21 of the plurality of carriages 21 starts moving at its movement start timing set based on the time elapsed since the start of the movement of the one carriage 21. Thus, a simple control makes it possible to prevent the support member 221 from sagging and to form images with a high throughput.

Further, according to the modification 2-2, the controller 30 performs the positional information obtaining process of obtaining the positional information on the position of each of the plurality of carriages 21 on the movement path Rmv, and in the drive control process, the controller 30 controls the linear motors 215 such that after one carriage 21 of the plurality of carriages 21 starts moving, the next carriage 21 of the plurality of carriages 21 starts moving at its movement start timing set based on the positional information on the position of the one carriage 21. Thus, a simple control makes it possible to prevent the support member 221 from sagging and to form images with a high throughput.

Further, the image forming operation unit 212 of each of the plurality of carriages 21 performs the operation when each of the plurality of carriages 21 is in the predetermined image forming region Rp of the movement path Rmv, and the first region A1 includes at least a portion of the image forming region Rp. This can prevent decrease in image quality due to sagging of the support member 221 in the image forming region Rp.

Further, the first region A1 is set between both ends of the image forming region Rp, thereby being set in the image forming region Rp. Hence, at least two carriages 21 can be simultaneously located in the image forming region Rp. Simultaneous/parallel ink ejection from the ink ejection heads 213 of the carriages 21 at this timing(s) makes it possible to form images in a shorter time.

Further, in the drive control process, the controller 30 controls the linear motors 215 such that at least two carriages 21 of the plurality of carriages 21 are simultaneously located in the image forming region Rp at a timing(s). This enables simultaneous/parallel ink ejection from the ink ejection heads 213 of two or more carriages 21 to the same recording medium P, and consequently makes it possible to form images in a shorter time.

Further, the image forming operation unit 212 of at least one carriage 21 of the plurality of carriages 21 includes the ink ejection head(s) 213 that ejects ink to the recording medium P, and the controller 30 performs the ejection control process of causing the ink ejection head(s) 213 to eject the ink at a timing(s) according to movement of the at least one carriage 21. This can prevent decrease in image quality due to sagging of the support member 221 and form images properly.

Further, the inkjet recording apparatus 1 further includes the cleaner(s) 23 that cleans the ink ejection head(s) 213 of the at least one carriage 21 located at a predetermined cleaning position outside the image forming region Rp, and in the drive control process, the controller 30 controls the linear motors 215 such that the at least one carriage 21 including the ink ejection head(s) 213 is located at the cleaning position while at least one other carriage 21 of the plurality of carriages 21 is located in the first region A1. This makes it possible to clean the ink ejection head(s) 213 during the image forming operation. Hence, as compared with a conventional technology of cleaning the ink ejection head(s) 213 not during the image forming operation, the throughput of image forming can be higher. Further, because the cleaner(s) 23 can be shared by two or more carriages 21, cost can be further reduced.

Further, the inkjet recording apparatus 1 further includes the capping unit(s) 24 that receives the ink ejected from the ink ejection head(s) 213 of the at least one carriage 21 located at a predetermined ink receiving position outside the image forming region Rp, and in the drive control process, the controller 30 controls the linear motors 215 such that the at least one carriage 21 including the ink ejection head(s) 213 is located at the ink receiving position while at least one other carriage 21 of the plurality of carriages 21 is located in the first region A1. This makes it possible to cause the ink ejection head(s) 213 to perform the flushing during the image forming operation. Hence, as compared with a conventional technology of causing the ink ejection head(s) 213 to perform the flushing not during the image forming operation, the throughput of image forming can be higher. Further, because the capping unit(s) 24 can be shared by two or more carriages 21, cost can be further reduced.

Further, the image forming operation unit 212 of a carriage 21 of the at least one carriage 21 includes the first ink ejection heads 213 that eject the ink of basic colors, the image forming operation unit 212 of another carriage 21 of the at least one carriage 21 includes the second ink ejection head(s) 213 that ejects the ink of not any of the basic colors but an auxiliary color(s), and in the ejection control process, the controller 30 causes the ink ejection head(s) 213 of the at least one carriage 21 to eject the ink in a mode chosen between the first mode in which the first ink ejection heads 213 and the second ink ejection head(s) 213 eject the ink and the second mode in which the first ink ejection heads 213 eject the ink but the second ink ejection head(s) 213 does not eject the ink. Hence, image forming by a combination(s) of the basic color(s) and the auxiliary color(s) and image forming with the basic color(s) only can be easily switched and performed. Further, in the first mode in which the basic colors and the auxiliary color(s) are used in combination, the support member 221 can be efficiently prevented from sagging.

Further, according to the second embodiment to which the modification 1-3 is applied, the at least one carriage 21 includes at least two carriages 21, the ink ejection heads 213 of the image forming operation units 212 of the at least two carriages 21 eject the ink of the same color(s), and in the ejection control process, the controller 30 causes the ink ejection heads 213 of the at least two carriages 21 to eject the ink such that ink droplets of the ink ejected from the ink ejection heads 213 land on the recording medium P placed on the placement surface 13a so as to be laid on top of one another. Hence, adjusting the amounts of ink ejected from the ink ejection heads 213 of the respective carriages 21 can adjust the density of images to be formed.

Further, according to the second embodiment to which the modification 1-3 is applied, in the ejection control process, the controller 30 causes the ink ejection head(s) 213 of a carriage 21 of the at least two carriages 21 to eject the ink to the recording medium P placed on the placement surface 13a, thereby supplementing the ink not ejected from the ink ejection head(s) 213 of another carriage 21 of the at least two carriages 21. This can prevent decease in image quality even when any of the carriages 21 has an ink ejection head(s) 213 having a nozzle(s) N that is defective in ink ejection.

Further, according to the second embodiment to which the modification 1-4 is applied, the at least one carriage 21 includes at least two carriages 21, the ink ejection heads 213 of the image forming operation units 212 of the at least two carriages 21 eject the ink of the same color, the ink ejection heads 213 each include nozzles N from which the ink is ejected disposed at intervals of a predetermined distance in the arrangement direction that is perpendicular to the moving direction of the plurality of carriages 21, the moving direction being along the movement path Rmv, and the ink ejection heads 213 of the at least two carriages 21 are disposed such that the positions of the nozzles N of the ink ejection heads 213 in the arrangement direction are different from one another. Thus, a simple configuration makes it possible to increase the recording resolution of images in the sub-scanning direction.

Further, according to the second embodiment to which the modification 1-5 is applied, the ink ejection head(s) 213 ejects the ink that is cured by being irradiated with an ultraviolet ray(s), and the image forming operation unit 212 of at least one carriage 21 of the plurality of carriages 21 includes the ultraviolet irradiator 217 that irradiates the ink ejected on the recording medium P with the ultraviolet ray. This makes it possible to cure ink in the main-scanning operation, which is performed by the carriages 21. Because no separate device that emits ultraviolet rays needs to be provided outside the carriages 21, cost can be reduced.

Further, according to the second embodiment to which the modification 1-5 is applied, the image forming operation unit 212 of at least one carriage 21 of the plurality of carriages 21 includes the functional fluid applier 218 that applies a predetermined functional fluid to the recording medium P. This makes it possible to apply a functional fluid to the recording medium P in the main-scanning operation, which is performed by the carriages 21. Because no separate device that applies a functional fluid needs to be provided outside the carriages 21, cost can be reduced.

Further, the inkjet recording apparatus 1 further includes the conveyor 10 that moves the placement surface 13a of the placement member 13 in the conveying direction that intersects the moving direction of the plurality of carriages 21, the moving direction being along the movement path Rmv, thereby conveying the recording medium P in the conveying direction. This makes it possible to form an image in a desired area of the recording medium P by alternating the main-scanning operation, which is performed by the carriages 21, with the sub-scanning operation, which is performed by the conveyor 10.

Further, the carriage driving method according to the second embodiment includes, in response to at least two carriages 21 of the plurality of carriages 21 being moving along the movement path Rmv, controlling the linear motors 215 such that the distance between any two adjacent carriages 21 of the plurality of carriages 21 in the first region A1 is longer than the distance between the any two adjacent carriages 21 in the second region A2/A3. This method can prevent the problems caused by sagging of the support member 221 from arising and form images properly. Further, this method can form images in a short time and make the throughput of image forming higher, while cost can be reduced.

The present invention is not limited to the above-described embodiments or the like, and hence can be variously modified.

For example, the number and the arrangement of ink ejection heads 213 disposed on each carriage 21 and the number of ink colors of the ink ejection heads 213 in the first embodiment and the second embodiment are merely examples, and hence can be appropriately changed according to the contents of images to be formed.

Further, in the first embodiment, the limit-imposed region R1 is set between both ends of the image forming region Rp, thereby being set in the image forming region Rp, but not limited thereto. The limit-imposed region R1 may coincide with the image forming region Rp, or may be wider than the image forming region Rp and include the entire image forming region Rp.

Further, in the second embodiment, the first region A1 and the limit-imposed region R1 are each set between both ends of the image forming region Rp, thereby being set in the image forming region Rp, but not limited thereto. The first region A1 or the limit-imposed region R1 may coincide with the image forming region Rp, or the first region A1 and/or the limit-imposed region R1 may be wider than the image forming region Rp and include the entire image forming region Rp.

Further, in the second embodiment, the limit-imposed region R1 is the first region A1 excluding both ends, but not limited thereto. The limit-imposed region R1 may be any region (region having any size) between both ends of the first region A1.

Further, in the first embodiment and the second embodiment, the cleaners 23 are disposed on only one side on the movement path Rmv in the main-scanning direction, but may be disposed on both sides on the movement path Rmv. This allows the cleaners 23 to clean the ink ejection heads 213 of the carriages 21 both in the standby time after outward printing and in the standby time after homeward printing.

Further, in the first embodiment and the second embodiment, the capping units 24 are disposed on only one side on the movement path Rmv in the main-scanning direction, but may be disposed on both sides on the movement path Rmv. This allows the ink ejection heads 213 of the carriages 21 to perform the flushing both in the standby time after outward printing and in the standby time after homeward printing.

Further, the auxiliary colors are not limited to LM, LC, 0 and G, and hence as the auxiliary colors, any color other than the basic colors, such as B (blue) and R (red), can be used.

Although some embodiments or the like of the present invention have been described and illustrated in detail, the disclosed embodiments or the like are made for purposes of not limitation but illustration and example only. The scope of the present invention should be interpreted by terms of the appended claims. That is, the scope of the present invention includes the scope of claims below and their equivalents.

What is claimed is:

1. An image forming apparatus comprising:
a placement member having a placement surface on which a recording medium is placed;
a plurality of carriages each including an image forming operation unit that performs an operation for forming an image on the recording medium placed on the placement surface;
a support member that supports the plurality of carriages such that the plurality of carriages are reciprocally movable along a predetermined movement path over the placement surface;
a driver that moves the plurality of carriages along the movement path independently from one another; and
a hardware processor that performs a drive control process of controlling the driver, wherein
in the drive control process, in response to at least two carriages of the plurality of carriages being moving along the movement path, the hardware processor controls the driver such that the number of carriages in a predetermined limit-imposed region of the movement path is equal to or less than a predetermined upper limit number that is less than the number of the plurality of carriages.

2. The image forming apparatus according to claim 1,
wherein the hardware processor performs a positional information obtaining process of obtaining positional information on a position of each of the plurality of carriages on the movement path, and
wherein in the drive control process, the hardware processor controls the driver such that after one carriage of the plurality of carriages starts moving, a next carriage of the plurality of carriages starts moving at a movement start timing set based on the positional information on the position of the one carriage.

3. The image forming apparatus according to claim 1, wherein in the drive control process, the hardware processor controls the driver such that after one carriage of the plurality of carriages starts moving, a next carriage of the plurality of carriages starts moving at a movement start timing set based on a time elapsed since the start of the movement of the one carriage.

4. The image forming apparatus according to claim 1,
wherein the image forming operation unit of each of the plurality of carriages performs the operation when each of the plurality of carriages is in a predetermined image forming region of the movement path, and
wherein the limit-imposed region includes at least a portion of the image forming region.

5. The image forming apparatus according to claim 4, wherein the limit-imposed region is set between both ends of the image forming region, thereby being set in the image forming region.

6. The image forming apparatus according to claim 4, wherein in the drive control process, the hardware processor controls the driver such that at least two carriages of the plurality of carriages are simultaneously located in the image forming region at a timing.

7. The image forming apparatus according to claim 4,
wherein the image forming operation unit of at least one carriage of the plurality of carriages includes an ink ejection head that ejects ink to the recording medium, and
wherein the hardware processor performs an ejection control process of causing the ink ejection head to eject the ink at a timing according to movement of the at least one carriage.

8. The image forming apparatus according to claim 7, further comprising a cleaner that cleans the ink ejection head of the at least one carriage located at a predetermined cleaning position outside the image forming region, wherein
in the drive control process, the hardware processor controls the driver such that the at least one carriage including the ink ejection head is located at the cleaning position while at least one other carriage of the plurality of carriages is located in the limit-imposed region.

9. The image forming apparatus according to claim 7, further comprising an ink receiver that receives the ink ejected from the ink ejection head of the at least one carriage located at a predetermined ink receiving position outside the image forming region, wherein
in the drive control process, the hardware processor controls the driver such that the at least one carriage including the ink ejection head is located at the ink receiving position while at least one other carriage of the plurality of carriages is located in the limit-imposed region.

10. The image forming apparatus according to claim 7,
wherein the image forming operation unit of a carriage of the at least one carriage includes first ink ejection heads that eject the ink of basic colors,
wherein the image forming operation unit of another carriage of the at least one carriage includes a second ink ejection head that ejects the ink of not any of the basic colors but an auxiliary color, and
wherein in the ejection control process, the hardware processor causes the ink ejection head of the at least one carriage to eject the ink in a mode chosen between a first mode in which the first ink ejection heads and the second ink ejection head eject the ink and a second mode in which the first ink ejection heads eject the ink but the second ink ejection head does not eject the ink.

11. The image forming apparatus according to claim 7,
wherein the at least one carriage includes at least two carriages,
wherein the ink ejection heads of the image forming operation units of the at least two carriages eject the ink of a same color, and
wherein in the ejection control process, the hardware processor causes the ink ejection heads of the at least two carriages to eject the ink such that ink droplets of the ink ejected from the ink ejection heads land on the recording medium placed on the placement surface so as to be laid on top of one another.

12. The image forming apparatus according to claim 7,
wherein the at least one carriage includes at least two carriages,
wherein the ink ejection heads of the image forming operation units of the at least two carriages eject the ink of a same color, and
wherein in the ejection control process, the hardware processor causes the ink ejection head of a carriage of the at least two carriages to eject the ink to the recording medium placed on the placement surface, thereby supplementing the ink not ejected from the ink ejection head of another carriage of the at least two carriages.

13. The image forming apparatus according to claim 7,
wherein the at least one carriage includes at least two carriages,
wherein the ink ejection heads of the image forming operation units of the at least two carriages eject the ink of a same color,
wherein the ink ejection heads each include nozzles from which the ink is ejected disposed at intervals of a predetermined distance in an arrangement direction that is perpendicular to a moving direction of the plurality of carriages, the moving direction being along the movement path, and
wherein the ink ejection heads of the at least two carriages are disposed such that positions of the nozzles of the ink ejection heads in the arrangement direction are different from one another.

14. The image forming apparatus according to claim 7,
wherein the ink ejection head ejects the ink that is cured by being irradiated with an ultraviolet ray, and
wherein the image forming operation unit of at least one carriage of the plurality of carriages includes an ultraviolet irradiator that irradiates the ink ejected on the recording medium with the ultraviolet ray.

15. The image forming apparatus according to claim 1, wherein the image forming operation unit of at least one carriage of the plurality of carriages includes a functional fluid applier that applies a predetermined functional fluid to the recording medium.

16. The image forming apparatus according to claim 1, further comprising a conveyor that moves the placement surface of the placement member in a conveying direction that intersects a moving direction of the plurality of carriages, the moving direction being along the movement path, thereby conveying the recording medium in the conveying direction.

17. A carriage driving method for an image forming apparatus including: a placement member having a placement surface on which a recording medium is placed; a plurality of carriages each including an image forming operation unit that performs an operation for forming an image on the recording medium placed on the placement surface; a support member that supports the plurality of carriages such that the plurality of carriages are reciprocally movable along a predetermined movement path over the placement surface; and a driver that moves the plurality of carriages along the movement path independently from one another, the carriage driving method comprising:
in response to at least two carriages of the plurality of carriages being moving along the movement path, controlling the driver such that the number of carriages in a predetermined limit-imposed region of the movement path is equal to or less than a predetermined upper limit number that is less than the number of the plurality of carriages.

18. An image forming apparatus comprising:
a placement member having a placement surface on which a recording medium is placed;
a plurality of carriages each including an image forming operation unit that performs an operation for forming an image on the recording medium placed on the placement surface;
a support member that supports the plurality of carriages such that the plurality of carriages are reciprocally movable along a predetermined movement path over the placement surface;
a driver that moves the plurality of carriages along the movement path independently from one another; and
a hardware processor that performs a drive control process of controlling the driver,
wherein the movement path includes a first region and a second region near an end of the movement path compared with the first region, and
wherein in the drive control process, in response to at least two carriages of the plurality of carriages being moving along the movement path, the hardware processor controls the driver such that a distance between any two adjacent carriages of the plurality of carriages in the first region is longer than a distance between the any two adjacent carriages in the second region.

19. The image forming apparatus according to claim 18, wherein the second region is disposed on each of both sides of the first region.

20. The image forming apparatus according to claim 18, wherein in the drive control process, the hardware processor controls the driver such that the number of carriages in a predetermined limit-imposed region that is set between both ends of the first region, thereby being set in the first region, is equal to or less than a predetermined upper limit number that is less than the number of the plurality of carriages.

21. The image forming apparatus according to claim 18, wherein in the drive control process, the hardware processor controls the driver such that after one carriage of the plurality of carriages starts moving, a next carriage of the plurality of carriages starts moving at a movement start timing set based on a time elapsed since the start of the movement of the one carriage.

22. The image forming apparatus according to claim 18,
wherein the hardware processor performs a positional information obtaining process of obtaining positional information on a position of each of the plurality of carriages on the movement path, and
wherein in the drive control process, the hardware processor controls the driver such that after one carriage of the plurality of carriages starts moving, a next carriage of the plurality of carriages starts moving at a movement start timing set based on the positional information on the position of the one carriage.

23. The image forming apparatus according to claim 18,
wherein the image forming operation unit of each of the plurality of carriages performs the operation when each of the plurality of carriages is in a predetermined image forming region of the movement path, and
wherein the first region includes at least a portion of the image forming region.

24. The image forming apparatus according to claim 23, wherein the first region is set between both ends of the image forming region, thereby being set in the image forming region.

25. The image forming apparatus according to claim 23, wherein in the drive control process, the hardware processor controls the driver such that at least two carriages of the plurality of carriages are simultaneously located in the image forming region at a timing.

26. The image forming apparatus according to claim 23,
wherein the image forming operation unit of at least one carriage of the plurality of carriages includes an ink ejection head that ejects ink to the recording medium, and
wherein the hardware processor performs an ejection control process of causing the ink ejection head to eject the ink at a timing according to movement of the at least one carriage.

27. The image forming apparatus according to claim 26, further comprising a cleaner that cleans the ink ejection head of the at least one carriage located at a predetermined cleaning position outside the image forming region, wherein
in the drive control process, the hardware processor controls the driver such that the at least one carriage including the ink ejection head is located at the cleaning position while at least one other carriage of the plurality of carriages is located in the first region.

28. The image forming apparatus according to claim 26, further comprising an ink receiver that receives the ink ejected from the ink ejection head of the at least one carriage located at a predetermined ink receiving position outside the image forming region, wherein
in the drive control process, the hardware processor controls the driver such that the at least one carriage including the ink ejection head is located at the ink receiving position while at least one other carriage of the plurality of carriages is located in the first region.

29. The image forming apparatus according to claim 26,
wherein the image forming operation unit of a carriage of the at least one carriage includes first ink ejection heads that eject the ink of basic colors,
wherein the image forming operation unit of another carriage of the at least one carriage includes a second ink ejection head that ejects the ink of not any of the basic colors but an auxiliary color, and
wherein in the ejection control process, the hardware processor causes the ink ejection head of the at least one carriage to eject the ink in a mode chosen between a first mode in which the first ink ejection heads and the second ink ejection head eject the ink and a second mode in which the first ink ejection heads eject the ink but the second ink ejection head does not eject the ink.

30. The image forming apparatus according to claim 26,
wherein the at least one carriage includes at least two carriages,
wherein the ink ejection heads of the image forming operation units of the at least two carriages eject the ink of a same color, and
wherein in the ejection control process, the hardware processor causes the ink ejection heads of the at least two carriages to eject the ink such that ink droplets of the ink ejected from the ink ejection heads land on the recording medium placed on the placement surface so as to be laid on top of one another.

31. The image forming apparatus according to claim 26,
wherein the at least one carriage includes at least two carriages,
wherein the ink ejection heads of the image forming operation units of the at least two carriages eject the ink of a same color, and
wherein in the ejection control process, the hardware processor causes the ink ejection head of a carriage of the at least two carriages to eject the ink to the recording medium placed on the placement surface, thereby supplementing the ink not ejected from the ink ejection head of another carriage of the at least two carriages.

32. The image forming apparatus according to claim 26,
wherein the at least one carriage includes at least two carriages,
wherein the ink ejection heads of the image forming operation units of the at least two carriages eject the ink of a same color,
wherein the ink ejection heads each include nozzles from which the ink is ejected disposed at intervals of a predetermined distance in an arrangement direction that is perpendicular to a moving direction of the plurality of carriages, the moving direction being along the movement path, and
wherein the ink ejection heads of the at least two carriages are disposed such that positions of the nozzles of the ink ejection heads in the arrangement direction are different from one another.

33. The image forming apparatus according to claim 26,
wherein the ink ejection head ejects the ink that is cured by being irradiated with an ultraviolet ray, and
wherein the image forming operation unit of at least one carriage of the plurality of carriages includes an ultraviolet irradiator that irradiates the ink ejected on the recording medium with the ultraviolet ray.

34. The image forming apparatus according to claim 18, wherein the image forming operation unit of at least one carriage of the plurality of carriages includes a functional fluid applier that applies a predetermined functional fluid to the recording medium.

35. The image forming apparatus according to claim 18, further comprising a conveyor that moves the placement surface of the placement member in a conveying direction that intersects a moving direction of the plurality of carriages, the moving direction being along the movement path, thereby conveying the recording medium in the conveying direction.

36. A carriage driving method for an image forming apparatus including: a placement member having a placement surface on which a recording medium is placed; a plurality of carriages each including an image forming operation unit that performs an operation for forming an image on the recording medium placed on the placement surface; a support member that supports the plurality of carriages such that the plurality of carriages are reciprocally movable along a predetermined movement path over the placement surface; and a driver that moves the plurality of carriages along the movement path independently from one another, the carriage driving method comprising:
in response to at least two carriages of the plurality of carriages being moving along the movement path, controlling the driver such that a distance between any two adjacent carriages of the plurality of carriages in a first region is longer than a distance between the any two adjacent carriages in a second region, wherein
the movement path includes the first region and the second region near an end of the movement path compared with the first region.
